(19) United States
(12) Patent Application Publication
(10) Pub. No.: US 2002/0035571 A1
(43) Pub. Date: Mar. 21, 2002

(54) Digital patent marking method

(76) Inventor: John H. Coult, Chicago, IL (US)

Correspondence Address: John H Coult, Suite 100, 1129 W Wellington Avenue, Chicago, IL, 60657, US

(21) Appl. No.: 09/946,009

(22) Filed: Sep. 4, 2001

Related U.S. Application Data
(60) Provisional application No. 60/233,324, filed on Sep. 15, 2000.
(60) Provisional application No. 60/289,422, filed on May 8, 2001.

(51) Int. Cl. G06F 17/30

(52) U.S. Cl. 707/104.1; 707/5

(57) ABSTRACT

A method of patent marking products comprises providing digital data identifying one or more patents related to predetermined products in a patent marking sense, and facilitating access to the digital data such that at least the numbers of the one or more related patents can be ascertained. One disclosed execution involves acquiring or developing a patent-product map which correlates product attributes, identifiers or other product data regarding predetermined products with the numbers of patents which relate to the products in a patent marking sense. The map is made available on a remotely accessible patent marking link such that upon accessing the link, patent marking information concerning the predetermined products can be ascertained. The maps are utilized to provide patent numbers correlated with products. In all more than 20 executions of the invention are disclosed.

### CROSS-REFERENCE TO RELATED APPLICATIONS

The application claims priority based upon provisional applications Ser. No. 60/233,324 (Sep. 15, 2000) and Ser. No. 60/289,422 (May. 8, 2001), both entitled Digital Patent Marking Method.

### BACKGROUND OF THE INVENTION

The patent laws in the United States limit damages for patent infringement prior to the giving of actual and unequivocal notice of infringement by the patent owner to the alleged infringer, unless the patent owner has given constructive notice of the existence of a relevant patent or patents. This is accomplished in accordance with the law by marking the product embodying the patented invention or its package with the pertinent patent number(s). Patentees who do not distribute the patented product are immune from the requirement to mark, as there is no product upon which the marking might be placed. Pure method patents are also free of the requirement because of the impracticability of marking. The patent marking requirement does not impose a severe burden on manufacturers of a modest variety of easily marked products owning a limited number of related patents, however, the marking requirement is so burdensome as to render it useless:

1) Where the types and models of products number in the thousands, as is the case with many large conglomerate manufacturing companies today;

2) Where the number of patents owned by the manufacturer numbers in the hundreds or thousands;

3) Where the patent owner is multinational or distributes globally and must deal with the patent marking requirements in various countries, the difficulty in tracking foreign patent coverage, and product models adapted for foreign manufacture and/or distribution;

4) Where by the nature of the product—integrated circuits, for example, conventional marking may be difficult;

5) Where logistics render difficult the maintaining of patent marking, once initiated, “consistently and continually” over extended periods of time, as required by law;

6) Where the financial and/or manpower resources of producing large numbers of product-and-patent-specific markings renders the activity cost ineffective;

7) Where the law requires that not only a patented system be patent marked, but also individual components of the system;

8) Where the law requires express and implied licensees and sublicensees to patent mark the licensed products; and

9) Where the cost in patent legal resources of determining which patents apply to which products is high.

Because of the many difficulties of meeting patent marking requirements, few companies effectively use patent marking today as a way to enhance damage recovery opportunities or licensing revenues. As a result, most companies forced to litigate against appropriators of their patented technologies find their potential damage recovery to be limited to a period starting when actual notice of infringement is transmitted to the alleged infringer, or failing that, to a period beginning with the initiation of litigation. Further, they are unable to recover for prejudgment interest, aggravated damages, damages pertinent to convoyed sales, and so forth in the period of infringing use when the relevant products were not appropriately patent marked.

Patent owners settling with users of their patented technology often find that they are unable to demand tribute prior to the date of licensing or initiation of licensing negotiations because they have not triggered a right to earlier tribute through legally effective patent marking. Copycats are free to identify and mimic products embodying advanced technology which are known to be patented but which do not contain a patent marking. If their use goes undetected, they may appropriate the originator's patented technology indefinitely. If detected and given actual notice of infringement, they often disappear, declare bankruptcy, reorganize with a new name, or otherwise evade recompense equitably owed to the patent owner. Even if the patent owner is ultimately able to obtain a license or an injunction from the copycat, the copycat may have had many years of free use of the originator's technology. Companies that have a legitimate interest in producing a competitor's product of manufacture and would be willing to pay for a license have difficulty learning whether a product on the market may be protected by one or more patents. This uncertainty and confusion impedes commerce in the free market. Unpatented products or features are available to be copied, and the law encourages same, however, patented products or features should not be available to be copied. But knowing whether a product or feature is patented or unpatented is difficult under today's cumbersome patent marking practices which discourage patent marking.

The losses to patent owners in litigation damages or settlements or licensing revenues as a result of failing to give legally effective constructive notice through patent marking is believed to equal hundreds of millions or more dollars each year in the United States alone.

The framers of the patent marking laws had an equal concern for the public. The advancement of technology and commerce is accelerated if confusion and uncertainty about whether a product is patented is minimized. The patent system in one sense is intended to spur the advance of technology by encouraging competitors to design around and improve upon existing products in ways which do not infringe on existing patents. The patent marking laws further this goal by making available to competitors knowledge about whether a particular product or feature of interest is patented, and specifically through which particular patents.

This intended incentive is frustrated however, if the patent marking laws, rooted in ancient technology, are so difficult, or even impossible in some cases, to comply with that they are not widely employed. Thus, not only do manufacturers suffer by the present state of patent marking practices, but so also does the public which is not readily provided with the patent data needed to resolve business issues on whether and/or how to compete with a competitor.

### OBJECTS OF THE INVENTION

It is a primary object of the present invention to provide an improved method for facilitating patent marking which accords with United States patent laws.

It is another primary object of the invention to provide such an improved method that will enable greater utilization of the patent marking laws, and which will therefore significantly enhance the revenue opportunities for patent owners who are pursuing litigation or licensing activities.

It is another object of the invention to provide an improved patent marking method that is simple to execute, low in cost, and which readily accommodates the patent marking needs of manufacturers with hundreds or even thousands of products and patents.

It is yet another object to provide an improved patent marking method which can be readily employed with diverse types of products, and which is conveniently and inexpensively maintained consistently and continuously over long periods of time.

It is still another object to provide such method that requires little capital investment, which can be implemented quickly throughout a global enterprise, and which is flexible in its application.

It is another object to provide such method in one aspect which does not require separate labels or other markings to be respectively associated with particular products, and which is thus inexpensive to originate and maintain by legal staff and production personnel.

It is another object of the invention to provide such a method by which the patent data to be marked can be easily and quickly revised, manually or automatically, to add, delete or correct data.

It is an object to provide such a method that is so convenient and inexpensive that licensees and sublicensees, express and implied, may more readily be induced by licensors to patent mark licensed products.

It is yet another object to provide a patent marking which will be widely used, making it possible for all to know whether a product or feature is patented in order that ethical competitors may know what design limitations are imposed upon its corresponding product or feature in order to avoid infringement, and whether patent protection is so broad as to make design-around impracticable.

It is another object of the invention to impede the free use by copiers of patented but unmarked products and features until such time as their appropriation is detected.

### BRIEF DESCRIPTION OF THE FIGURES

FIGS. 1A-1F depict six basic executions of the invention;

FIG. 1 is a generalized representation of the principles of the invention;

FIG. 2 is a diagrammatic depiction of an elaboration of one aspect of the FIG. 1A execution of the invention;

FIGS. 2A and 2B depict an elaboration of an aspect of the FIG. 1C execution of the invention;

FIG. 3 depicts another execution of the invention; and

FIGS. 4, 5-6, 7 and 8 depict four additional executions of the principles of the invention.

### DESCRIPTION OF THE PREFERRED EMBODIMENTS OF THE INVENTION

The present invention is intended to facilitate full use of the patent marking laws through the application of modem digital data storage, retrieval and processing technology, network communication technology and other state-of-the-art technologies. The current techniques of patent marking typically involve applying to the products being marked molded or engraved inscriptions, or paper, plastic or metal labels exhibiting in alphanumeric text the marked patent numbers. These techniques employ three-century-old technology so cumbersome and expensive as to be economically prohibitive in many instances.

For the reasons given above, many manufacturers today forsake the significant benefits of patent marking their products, introducing their products into commerce where they may be mimicked by copiers until identified and enjoined or licensed, or more often until the copier disappears, declares bankruptcy, reorganizes, or otherwise makes itself unreachable. This free ride on originators technology is costing manufacturers in the United States and other countries billions of dollars annually.

Imagine a future world, however, where in a manufacturer's production management system or enterprise planning system, as a product label is about to be printed, a system memory connected to a URL or other online patent marking link is accessed, or the URL is accessed directly. Instantly the numbers of the patents which are relevant to a particular product being labeled are retrieved and printed on the label to create a legally effective, complete, and accurate patent marking notice. The notice contains the number of a patent which issued to the manufacturer the same day, having been entered in the provider's database and automatically correlated with the appropriate product or products of the manufacturer. In this future scenario, made possible by application of the present invention, a copier of the marked product is at risk for damages or license fees from the date of introduction of the thus-marked product.

The full constructive notice effect of patent marking envisioned by the legislators of the patent marking laws is realized, to the benefit of manufacturers and their competitors alike. The deserved high-technology image of the patent-marking manufacturer is promoted to the consuming public, and the constructive-notice effect of marked patent numbers to competitors is effectuated.

In another scenario, a manufacturer has no room on its product labels for the many applicable patent numbers. Rather than proceeding without a patent marking notice, it inscribes each label with a simple universal notice in the form of a patent marking link such as, “For relevant patents, please access on the Internet www.patentmarking.com”. Any would-be copier, legitimate design arounder, or other member of the public, upon accessing the indicated web site is quickly and easily guided to the numbers of the patents which apply to the manufacturer's many products, including the product so inscribed. The would-be copier or other member of the public quickly learns that the thus-marked product is covered by a number of patents. He is able to download copies of patents that pertain directly to the product feature of interest. His attorney advises that he avoid copying the product feature. Alternatively, his attorney may advise that the particular feature is not patented and can be copied. Or alternatively, his attorney may advise that the patent claims are narrow and can be readily avoided by a simple design change.

These future scenarios are but two among many which will be brought to fruition by application of the principles of the present invention. A few examples of the many possible executions of the present invention will be described later in this specification.

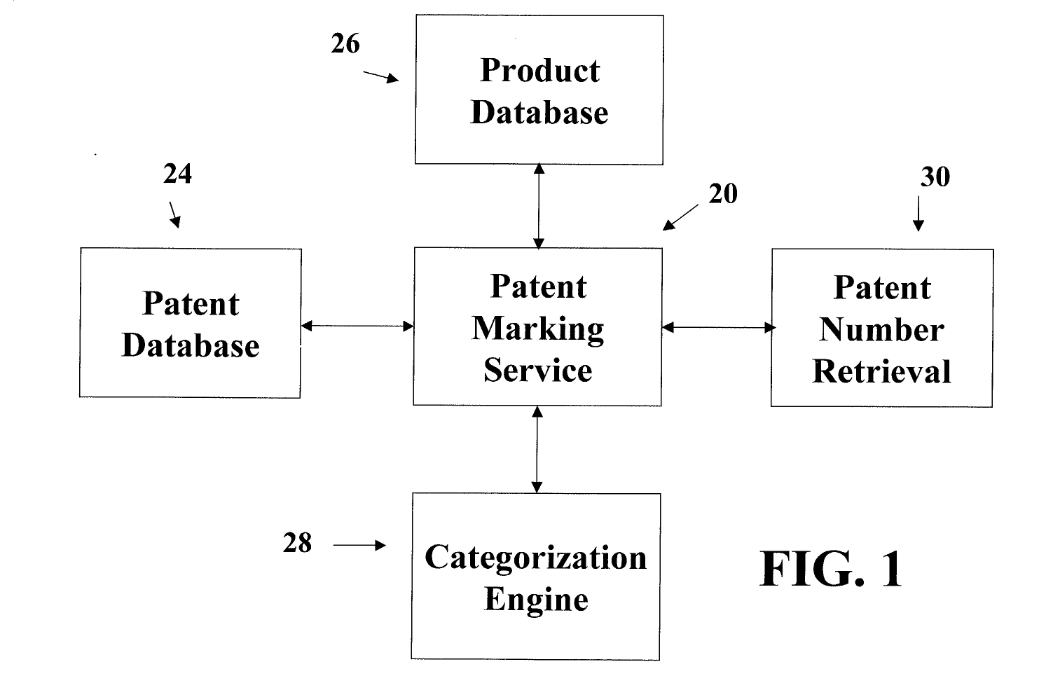

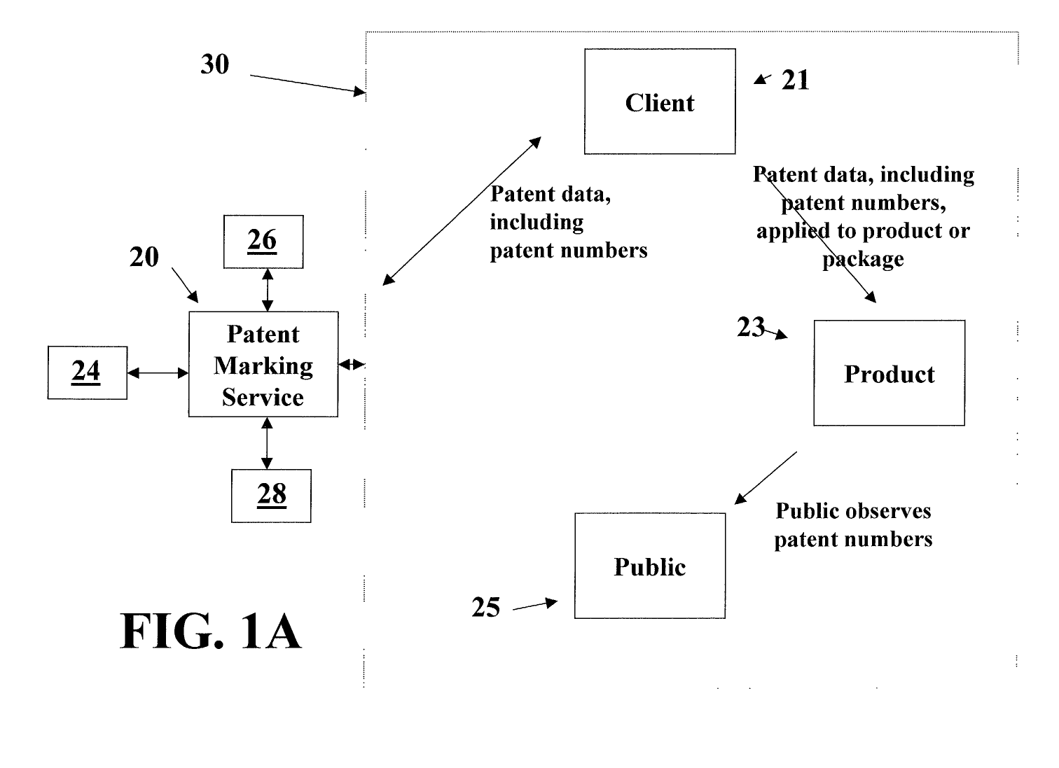

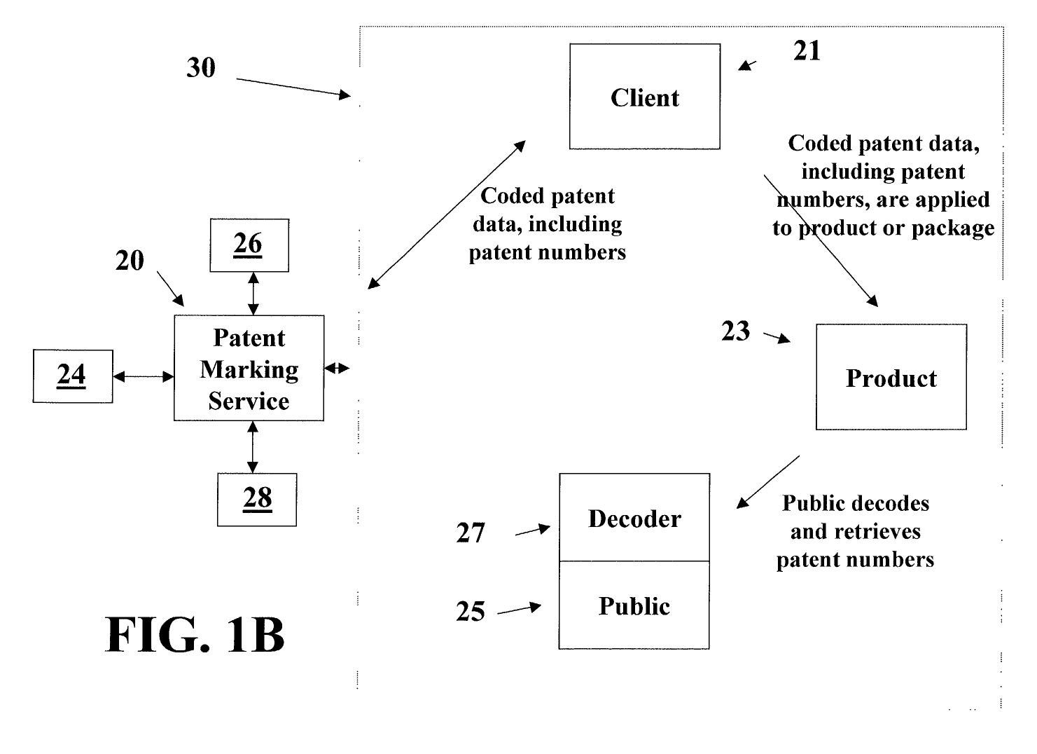

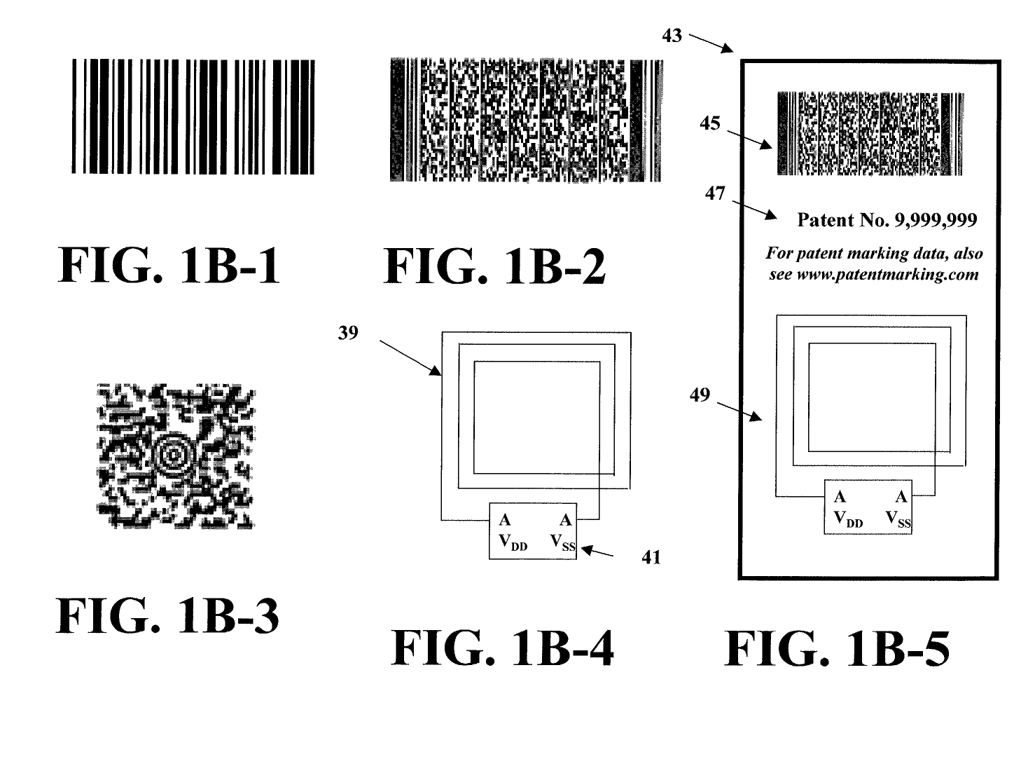

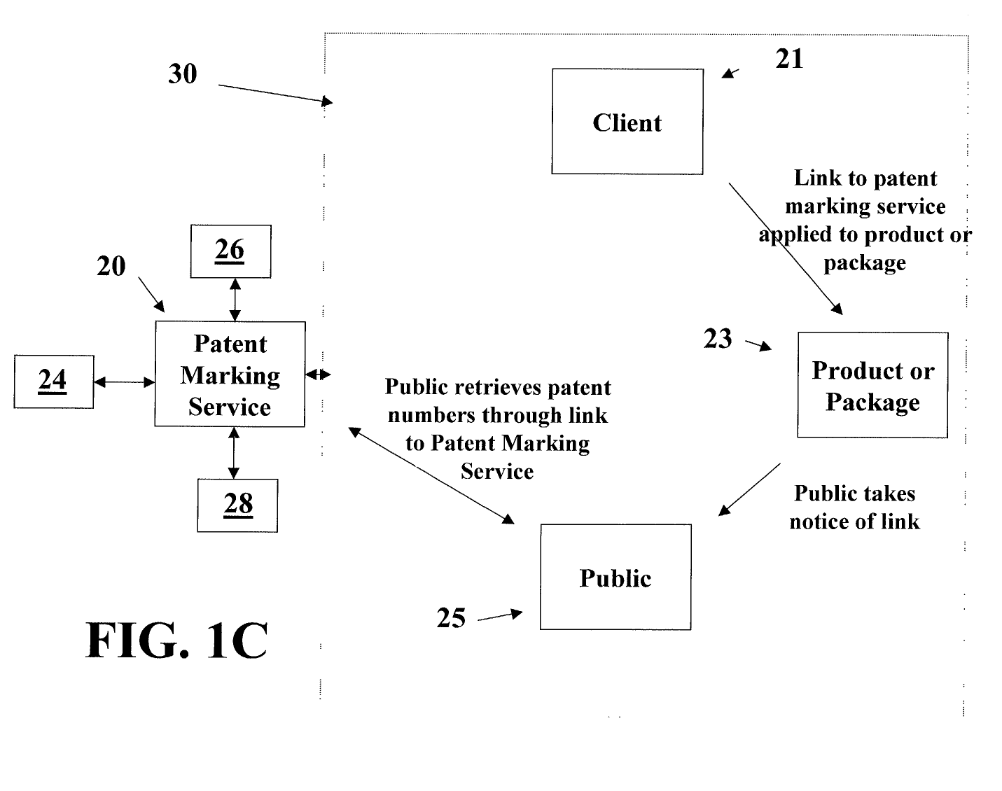

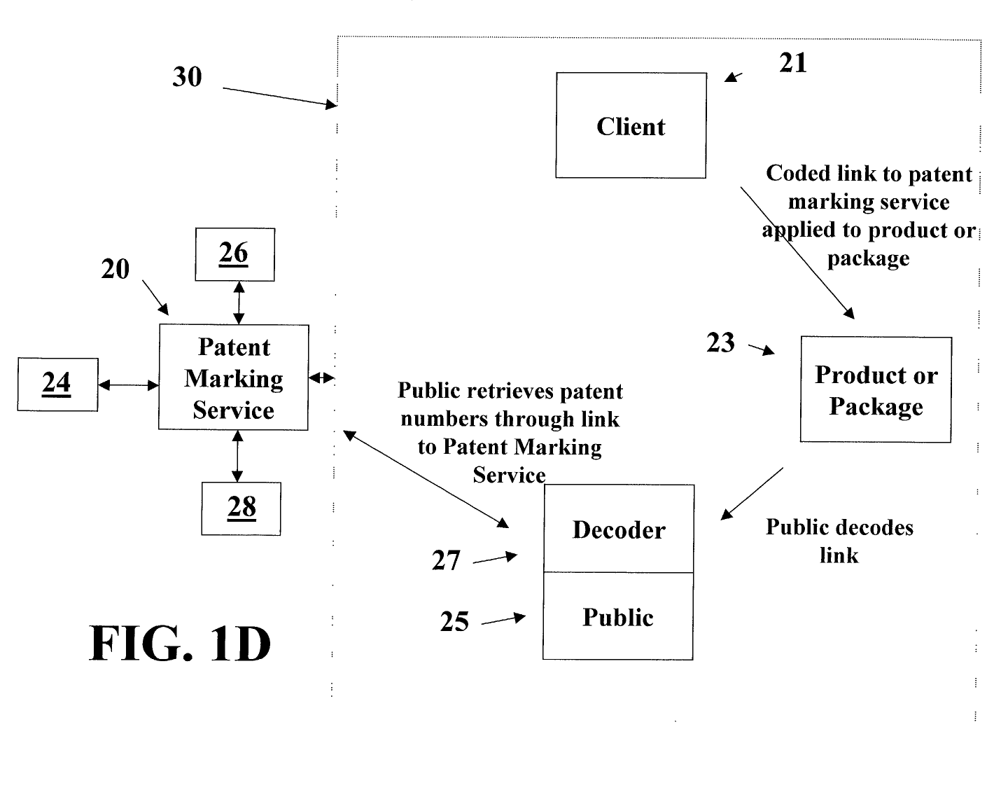

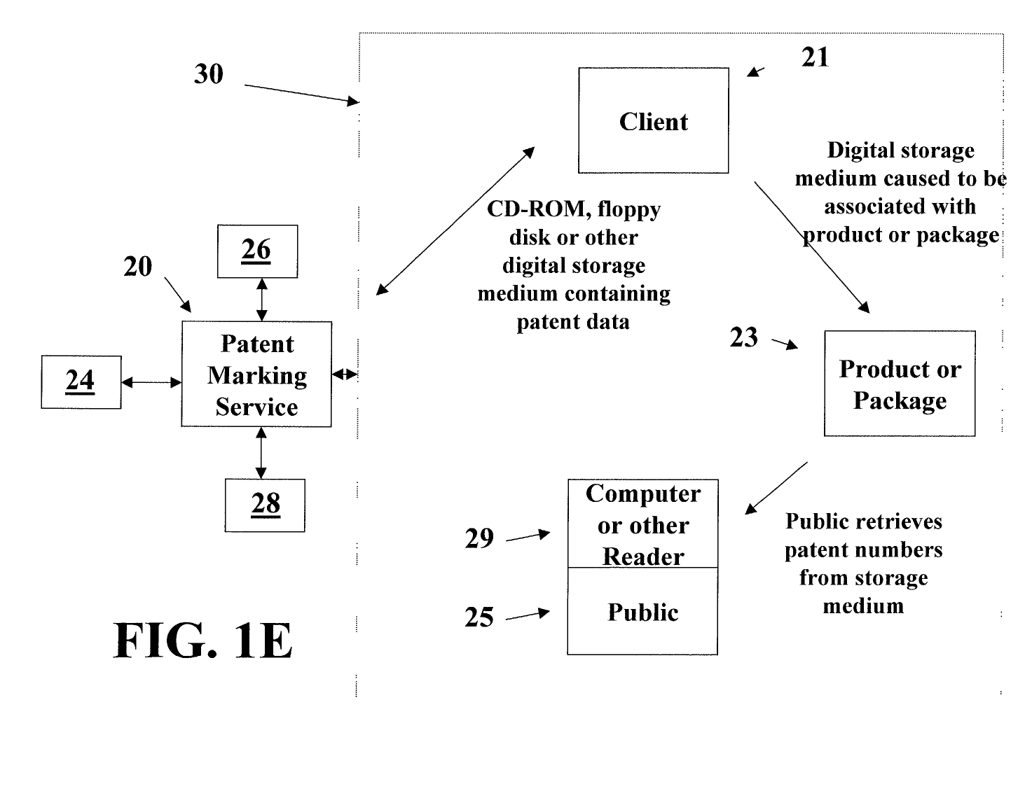

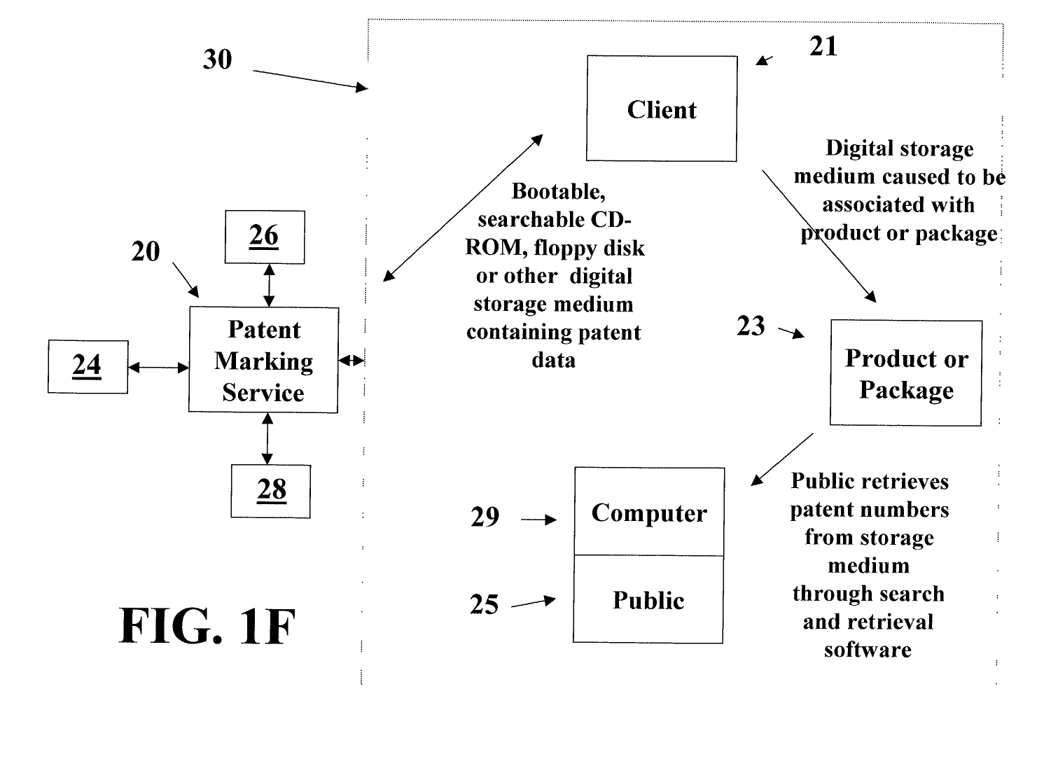

A system implementing the principles of the present invention is shown in highly schematic fashion in FIG. 1. Stated with utmost brevity, one aspect of a method of the present invention centers on the provision of a patent marking service 20 which utilizes a patent categorization engine 28 to process patent data in a patent database 24 against product data in a product database 26. Clients of the patent marking service 20 or other users retrieve or receive the patent-product data from the patent marking service 20 and use it in a variety of ways to patent mark products in accordance with the patent laws (denoted at 30 in FIG. 1). Before engaging a detailed description of the invention and various exemplary applications and executions of its teachings, a number of definitions will be given which will further an understanding of the ensuing description.

Definitions

As used herein the following terms have these definitions.

Patent Marking As a noun “patent marking” is intended to embrace both “direct patent marking” and “indirect patent marking”, as those terms are defined below, and means a constructive notice to the public of one or more patent numbers which may relate to an associated “product” in a patent marking sense. As a verb, it is intended to mean the act of applying a “direct patent marking” or an “indirect patent marking” on a “product” with the intent of complying with the patent laws. A patent marking may be placed on the product itself, or on its packaging as appropriate. For intellectual property and other intangible products, particularly products such as downloaded software which has no package, the patent marking notice must be given in the best way or ways possible, including: 1) upon installation or boot-up of the software; 2) in the digital license agreement; 3) as a pop-up during use of the software, 4) in the electronic user's manual, and so forth. As will be explained below, foreign patent numbers can be patent marked on products produced for export. Also the numbers of published patent applications.

Direct Patent Marking A patent marking which provides to the end user the number(s) of one or more patents directly, with or without the use of a “patent marking link”, as defined herein. A “direct patent marking” may be a coded or uncoded machine readable and/or editable patent marking, as defined herein, or may present the patent number information as humanreadable alphanumeric text.

Indirect Patent Marking An “indirect patent marking” does not provide on its face, or otherwise directly, the number(s) of one or more patents, but rather provides a “patent marking link”, as defined herein.

Patent Marking Link A “patent marking link” is a constructive patent marking notice which provides a link to a source of one or more patent numbers which are relevant to the marked products in a patent marking sense. A “direct patent marking” may be included with the patent marking link. A patent marking link may take a variety of forms, including but not limited to the following.

URL (Uniform Resource Link) Defines the route to a file on the World Wide Web or any other Internet facility. URLs are typed into a browser to access Web pages, and the URLs are embedded within the pages themselves to provide the hypertext links to other pages. The URL contains the protocol prefix, port number, domain name, subdirectory names and file name. In the example http://www.patentmarking.com/abc/patentlookup.html, “http” is the Web protocol, and www.patentmarking.com is the domain name. “abc” is an abbreviation of the name of ABC Company in a subdirectory. In a deeper subdirectory “patentlookup” is a page which may, for example, contain a lookup table of patents for ABC Company. Other Internet protocols include “ftp:” (file transfer protocol), news: (Usenet newsgroups), mailto: (email), “wais” (wide area information server); “gopher:” (Gopher server).

The term “patent marking link” is intended to be construed broadly to also include any location or facility where the actual patent numbers to be marked may be retrieved from or “pushed” to the user. The term is thus intended to include local or remote facilities which are accessible by telephone, television cable, LAN, WAN, MAN, intranet, extranet, email autoresponder, or other private or public communication link or service.

Coded Patent Marking A “coded patent marking” or “machine readable patent marking” is a form of “direct patent marking” which provides one or more patent numbers, but the patent numbers are not in alphanumeric or other human-readable format. A coded patent marking may include a patent marking link in addition to, or instead of, a direct patent marking.

A coded patent marking may take any of a variety of forms, including by way of example and not limitation, the following:

Bar Code Modem bar codes, particularly two-dimensional and three-dimensional bar codes, have sufficient storage capacity to provide the numbers of a significant number of patent numbers which may apply to a particular marked product. Bar code readers available today are capable of instantly displaying the encoded information on visual displays or providing an audible reproduction. In many applications the use of a bar code and bar code reader is an improvement over the human eye, particularly where the numbers are printed in small or difficult-to-read typeface. Bar code labels can display relevant patent data in machine readable form (bar codes) and concurrently print the appropriate numbers on the label in alphanumeric form for visual retrieval. As noted, a bar code can provide a patent marking link in lieu of, or in addition to, a direct patent marking.

RFID (Radio Frequency Identification) Present and developing RFID transponders can store kilobytes or megabytes of information—enough capacity to store the numbers of dozens, or even hundreds of patent numbers in some cases enough to store the front pages or even the entire text of the marked patents. One of the significant advantages of using RFID technology to provide patent notices, in addition to its high storage capacity, is the ease of data retrieval. With RFID patent marking technology as taught by this invention, a patent marking notice which may be hidden within the product (which is permitted by current law) can easily be read with an RFID reader. The user does not have to take the product apart and look for the patent marking notice on concealed surfaces or parts. Thirdly, patent marking notices applied to a group of products, or a group of patent marking notices on a single product, can be easily read remotely with an RFID reader. The cost of RFID labels and transponders is so low today that use of this technology does not impose a significant cost burden on most products. Fourth, RFID transponders ca be quickly and easily revised to add new patent numbers or to delete the numbers of patents that have expired, been rendered invalid or unenforceable, or were incorrectly included. Products that had already been patent marked and were resident in factory inventory or passing through the distribution system, can have their RFID transponders edited to add the number of a recently issued patent, for example. For additional details, see the discussion below regarding the FIG. 1B execution. It is noted that bar codes and RFID technology may be jointly employed. Direct patent marking, coded and uncoded, may be jointly employed with indirect patent marking.

Patent Marking Updating RFID technology offers one way to revise a patent marking notice, as will be explained in detail below. As used herein, “patent marking updating” means any use of digital electronic or other means to add to or otherwise change a previously made or applied patent marking, or to add a new patent marking where none existed before.

In applications where electronic communication is maintained with the patent marking service, revisions to patent marking data may be downloaded or otherwise communicated to purchasers or others in possession of patent-marked products after the purchase or product licensing has been made. The foundation for patent marking is constructive notice to the public of the existence of one or more patents which apply to the marked product. Exactly when the notice is received may, in certain applications, may not affect the legal efficacy of the patent marking notice. Certainly where the product is downloaded software, firmware or other content digital data licensed on a subscription basis, post-purchase patent marking notice or revised notice is valid notice. The invention may be employed, for example, to correct gaps or inconsistent patent marking in a factory, using downloading of electronic patent marking notices into or in association with previously purchased/licensed products, or to the purchasers/licensees where downloading into or in association with the product is not practicable.

Certainly post purchase/license patent marking according to the present invention gives notice to non-purchasing/licensing third parties who have access to the product.

Product A “product” is intended to mean anything that must be patent marked to enjoy the benefits of the patent marking laws, including (from 35USC101) any machine, process, manufacture, composition of matter or improvement of any of these, as well as components and features, and anything else (in the words of the United States Supreme Court) “under the sun made by man”.

Patent Database As used herein a “patent database” is a local or remote database of patents or patent data, or a plurality of databases of local or remote databases of patents or patent data. In certain applications of the invention, a patent marking service may employ a patent database to map, correlate or categorize patents with products to create a “patent-product map”, as defined herein. The patent data may be acquired and stored locally, or accessed remotely from public patent database sources such as the United States Patent and Trademark Office, the patent offices of other countries or multinational convention or treaty organizations such as the European Patent Office or the World Intellectual Property Organization, or from for-profit patent data providers such as Derwent, Inpadoc, MicroPatent, or Delphion, or from private patent portfolios of corporations, associations, or other organizations. The patent marking service receives new patent issues from the patent data sources and in certain applications of the invention, automatically pre-maps them to related products to create a “patent-product map” in anticipation of a client or user call for such information.

Patent-Product Mapping, Correlating, or Categorizing Central to this invention is the creation by a patent marking service of correlations of patents and products for patent marking purposes, either in real time in response to a call for patent data, or off line in advance of a call for patent data. In this patent application, the term “patent-product mapping” or “patent-product correlating” or “patent-product categorizing” shall be synonymous in meaning an interrelating of patents and the products or features to which the patents relate in a patent marking sense. The result of such an activity shall be termed herein a “patent-product map” or “patent-product correlation” or “patent-product categorization” or “patent-product data” intended to be employed for the purpose of patent marking products. Such a map or the like may, depending upon the application and the available patent and product data, be organized in the form of one-to-many, many-to-one, many-to-many, or one-to-one. A single patent correlated with a single product or feature may constitute a “patent-product map”, a “patent-product correlation”, a “patent-product categorization” or “patent-product data”.

In FIG. 1, the categorizing or mapping of patents to products is depicted schematically as being accomplished by a patent categorization engine 28. As used herein the term “categorization engine” is used metaphorically to mean any instrumentality or process—automated, semi-automated, or manual—by which a correlation of patents to products is accomplished. The patent marking service provides at least one, and preferably more than one, processes by which the patents in the patent database 24 are correlated with the product data in the product database 26 to develop in advance or in real time a patent-product map responsive to a an interested party's needs.

A preferred process is to develop in a data management system, a system of lookup tables. As noted, ideally the patent-product correlations for the lookup tables are provided by the manufacturer of products and other entities with the most intimate knowledge of patent-product relationships. The correlation will typically be between specific patent numbers and product identifiers. The possible product identifiers include product descriptions, brand names, trademarks, model numbers, part numbers, UPCs (Universal Product Codes), perceived USPTO and WIPO patent classification subclasses relevant to the camera's various technologies, keywords or other information useful in identifying or characterizing a product or its features or attributes. As new patents issue to the manufacturer, the manufacturer provides correlations of the new patent numbers to the patent marking service, and the patent marking service updates the lookup tables in its data management system. Alternatively, the patent marking service can develop the patent-product correlations.

In addition to, or instead of, lookup tables, or for use in preparing the lookup tables, the patent marking service may provide, as noted above, a categorization engine, which correlates patents with products (and which may itself create look-up tables).

Working offline, the patent marking service categorization engine correlates the products and product features derived from its product database 26 with identifiers (such as patent numbers) of patents derived from its patent database 24. The result is a mapping of patents to products, which is available in advance to serve client or other user calls for patent-product data. The results of a call for patent-product data can thus be much faster than if the correlation had to be performed in real time, particularly if vast amounts of product and patent data must be processed, as will often be the case. The same engine can perform correlations in real time if a requested patent-product map has not been archived.

The end objective of the patent-product mapping or categorization according to the invention is to service the needs of those who desire to know whether a product or product feature is patented, and if so, to also learn at least the numbers of those patents.

Many tools exist today, primarily software, to accomplish the functions of the patent categorization engine 28. In one execution that may be employed, the data in the product database 26 is organized and indexed according to physical, functional and/or performance attributes and descriptors, identifiers such as ownership, brand name, trademark, product number, model number, keywords, UPC code and the like and other data that can be useful in correlating a product or feature with a patent.

The data in the patent database 24 is organized and indexed according to bibliographic data, and technical description attributes (as characterized by keywords or natural language data), patent classification (United States Patent Classification and/or International Patent Classification).

The “categorization engine” (which may include manual operations) is capable, upon command, of using comparison, clustering, and other tools, to rigorously cross-correlate the indexed patent data with the indexed product data to produce patent-product maps of the contained data. These data are integrated with patent-product correlations that may be provided by manufacturers and stored, awaiting a call for selected data by clients or other users. Alternatively, as described herein, if a patent-product data map requested by a client or user has not been archived, the categorization engine will be run to develop the requested patent-product data or map.

In one execution of the invention, the categorization engine employs a number of the described patent-product correlation methods and compares the results to produce a final relevance ranked “best list” of patent numbers. The list of patents produced may be longer than an arbitrary number of patents deemed to be a reasonable number for the user to inspect. To overcome this potential overload, the system can be set to delete those patent numbers not meeting a set threshold.

Patent Marking Service As used herein, a “patent marking service” (20 in FIG. 1) may be a for-profit service entity, a not-for-profit entity such as a trade organization, an entity owning or managing a portfolio of patents to be marked, a manufacturer or assembler maintaining its own patent management service or system, or other entities. As described herein the chief functions for the patent marking service include (without limitation):

1) Building and maintaining a patent database and acquiring rights to process, copy, categorize, modify, and distribute patent numbers, copies and other patent data associated with patent data from a variety of public and private sources, as described herein;

2) Building and maintaining a product database and acquiring rights, as needed, to copy, categorize, modify, process, and distribute the product data and the results of processing such data with patent data;

3) Mapping, correlating, or categorizing (as those terms are defined herein) patent data and product data for the purpose of developing patent marking data for distribution to clients or other users;

4) Distributing the results of such mapping, correlating and/or categorizing to clients and other users, either in response to a query or request (“pull” mode) or as an update or other “push” mode service;

5) Contracting and otherwise arranging with clients and other users for the delivery of services including, but not limited to, providing the numbers of patents relevant in a patent marking sense to certain products or product features automatically, or in response to queries or requests from clients; and

6) Manually or automatically updating patent and product databases holding the patent data, product data, and correlated patent-product data, with additional patent and product data. The patents may be new issues, or additional portfolios of patents from clients or other sources. The product information may relate to recently introduced products, or may be batch or individual data entries relating to existing products or products no longer traded in commerce. The new data is integrated with existing data and correlated to expedite the delivery of requested patent marking information from clients and other users.

The availability of the patent marking service to serve the public and its clients serves a number purposes which inure to the benefit of clients and the public. First, the public can learn whether the technology underlying a specific patent is viable by accessing the patent marking service with the patent number and determining whether it has been marked on a product. This information can be valuable as part of pre-licensing, pre-purchase, or M&A due diligence. Second, a client can readily learn the percentage of its total portfolio which is being used to protect products.

Third, competitors or other members of the public can use the patent-product maps and correlations developed or developable by the patent marking service as a form of competitive intelligence. This can be accomplished by inputting to the service descriptors of various competitor products, components or features, and quickly learn which are patent marked, and if so with what patent numbers.

Having its patent marking data generally available to the public will benefit clients by enhancing knowledge of investors, customers and others of the advanced patented technology possessed by the clients. Further, the ready availability of knowledge of which products are patented and under which patents will significantly enhance the “scare-off” value of clients' patents, thereby lessening competition and future disputes. As described herein, a patent marking service may also be in-house and private, being maintained by a corporation to service its own needs, for example.

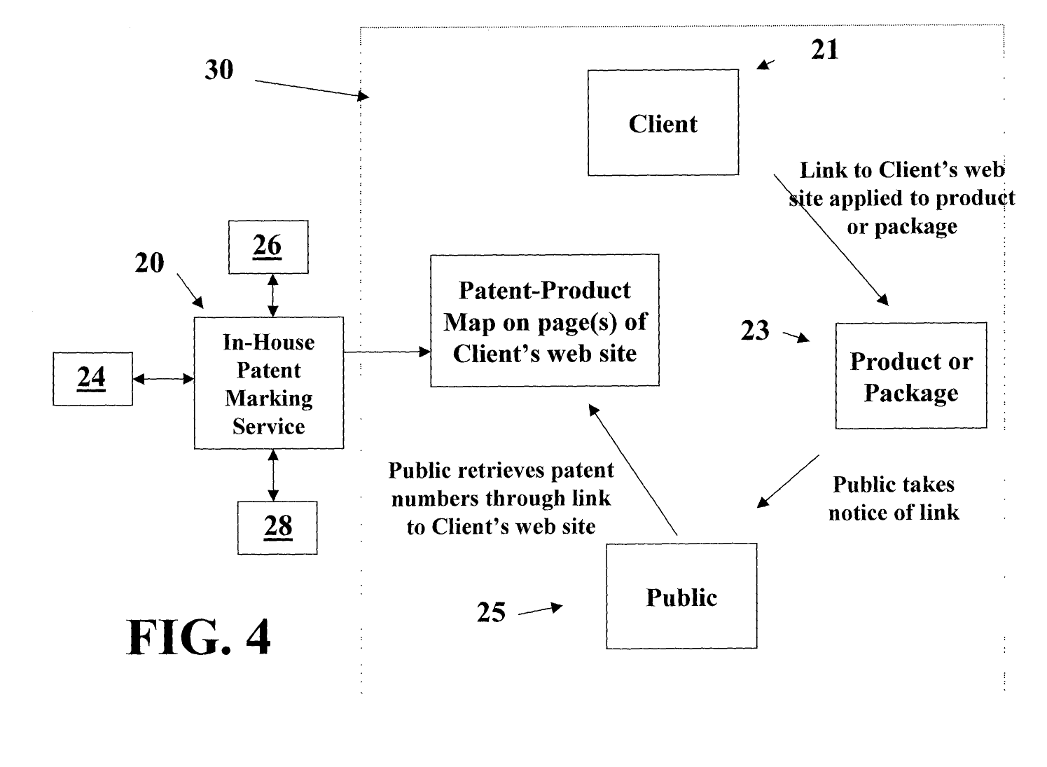

Patent Number Retrieval In a general sense, as used herein the terms “patent number retrieval” (30 in FIG. 1) or “patent number retrieving” or “patent-product retrieval” or similar expressions refers to the querying, requesting or other “pulling” of “patent-product data,” patent numbers or other such information from a patent marking service, or the “pushing” of updates of such information and other patent-product data to clients and other users. As will be explained in more detail herein, the retrieval processes within the scope of this invention are many and varied. For example, in certain applications a call from the public for relevant patent data may trigger a computer search of data stored on preloaded look-up tables. In another, the categorization engine may undertake a search in real time for the relevant patent numbers. In yet another, each client's patent data may be presented on a web page reserved for that client as a patent-product map or lookup table which the public itself browses visually or electronically. In still another application, as described in connection with the FIG. 4 execution, patent-product map data will be furnished to clients by the patent marking service, and the data will be posted on the client's own web site. Other variants are within the skill of the art.

Product Database As used herein a “product database” (26 in FIG. 1) is a database of products which a patent marking service employs to map, correlate or categorize with patents to create a “patent-product map”, “patent-product correlation”, or “patent-product data”, as defined herein. Sources of product information for collection in the database may be derived from manufacturers' or distributors' web sites, directories such as Thomas Register, test or evaluation services, and a vast array of other public and private sources. As noted, in many applications the highest quality information will be provided to the patent marking service by the manufacturers of the products to be patent marked. In accordance with the present invention, the patent marking service may arrange (by contract or otherwise) with manufacturers, distributors or other entities desiring to patent mark, or for other reasons to provide, as appropriate to the circumstance, product data in the form of product descriptions, brand names, trademarks, model numbers, part numbers, UPCs (Universal Product Codes), perceived USPTO and WIPO patent classification subclasses relevant to the product's various technologies, perceived USPTO and WIPO patent classification subclasses relevant to the product's various technologies, keywords, or descriptors or other information useful in identifying or characterizing a product or its features or attributes. In preferred arrangements patent data is correlated with the product information supplied.

In order to assure the accuracy of the patent-to-product (sometimes shortened herein to “patent-product”) mapping, as noted, the entity providing the product information will provide tables, or in other ways will correlate, individual products and/or features with the numbers of patents which relate thereto in a patent marking sense.

Further details about the patent marking service's databased product data will be found in the detailed executions of the invention described below.

Client As used herein, “client” is a general term used to refer to the party or parties which engage the patent marking service. The client may be a customer of a for-profit or not-forprofit patent marking service. If the patent marking service is an internal function in a corporation or other organization, the client would typically be another function within the organization which employs or uses the patent marking service.

Additional Patent Data In accordance with the present invention wherein patent marking data is processed in digital form and in some applications stored in digital form up to the point of delivery or presentation to the interested member of the public, a variety of additional patent data can be made available in addition to the patent numbers required by law. As used herein, “additional patent data” and similar terminology shall mean such data as patent bibliographic data; full or partial patent text; information regarding licensing availability, terms or contact persons, information regarding litigation or other inter-party disputes concerning the validity or infringement of the patent; related patents; foreign counterparts; ownership and other such data related to the marked patent.

Public The term “public” shall be used to mean any person or organization to which constructive notice is given by a patent marking notice. The public is generally any person or organization other than the patent marking service or the client. In a typical execution, the public will be a competitor of the producer of a patent-marked product, or one desiring to compete or to otherwise gain knowledge about the patent or patents covering a particular marked product.

This invention concerns a method of digital patent marking which brings into play modern digital information delivery, making possible the full use of patent marking to the benefit of manufacturers and the public which were intended by the framers of Section 287 of Title 35 of the United States Code which defines the laws of patent marking, and corresponding patent marking laws in foreign countries.

The method of the present invention concerns, in one aspect, an improved method of patent marking products in compliance with the patent laws. The method comprising: 1) providing digital data representing one or more patents relevant to certain products of a manufacturer, that is, patents which would be appropriate to associate with the products in a patent marking sense, and 2) facilitating access to the digital data such that an interested party can ascertain at least the numbers of the said relevant patents.

FIG. 1 is a high-level depiction of the method of the invention. At the core of the method is a categorization or mapping of patents to products. This will be accomplished according to the teachings of the invention by a patent marking service or entity (reference number 20 in FIG. 1). As will become clear as this description proceeds, such mapping or categorization or correlation of patents and products in some applications will be accomplished in advance of a call for information, as by providing a look-up table or other archived correlation which relates specific patents with one or more specific products. In other applications the function will be accomplished in real time, as through the use of a search engine, clustering tool or other means, as will be described.

In the practice of the present invention, a variety of parties will have an interest in retrieving patent-product mapping information from the patent marking service, including the following.

Manufacturers, Distributors, Licensees, Sales Forces As will be described in detail hereinafter, manufacturers, licensees, distributors and others in the sales function of corporations will be the major beneficiary of the present invention, retrieving patent-product data for the purpose of presenting patent information to the public in association with their products in such a way as to satisfy the patent marking laws. This will be accomplished by applying the retrieved patent-product data directly to products or their packages and in utilizing the digital data to presenting patent-product information to the public in other ways which satisfy the patent marking laws.

Shippers As will be detailed below, shippers such as UPS (United Parcel Service) and Federal Express, under arrangement with clients, may retrieve patent-product data and apply it to packages to assist the shipping manufacturer in complying with the patent laws.

Competitors, Associations, Users, Technology Seekers, and other Members of the General Public will use the patent-product data to better understand whether a product or its features are patented, and if so, by whom and under which patent numbers.

The patent-product data may be employed in various ways, including but not limited to:

Applied Directly to the Product, Component or Feature Patent-product data retrieved from the patent marking service may be employed in the factories, assembly lines, and other facilities of manufacturers, VARs (value-added retailers), assemblers, customers, component suppliers, and others. The use will typically be to download patent numbers into embedded software or firmware, or to create labels containing patent numbers relevant to the labeled products or a universal patent marking legend, or by screening the numbers or legend on such products, or by using the data to drive similarly programmed auto engravers, mold-making equipment or the like.

Applied Directly to the Package for the Product The users of patent-product data described immediately above may also apply the patent marking to product packages. Further, direct shippers, or package shippers such as Federal Express and United Parcel Service, as by arrangement with the manufacturer or other patent marking beneficiary, may apply the patent-product data to the packages for products.

Indirect Patent Marking Through the Use of a Patent Marking Link In accordance with an aspect of the invention, as intimated above and as will be explained in detail below, where room on the product is not available, where the numbers of products and/or patents is large, where time-to-marking is of the essence, or where other circumstances do not permit or encourage placement of the patent numbers on the product, the interested party may elect instead to mark the URL of the patent marking service web site, or a specific page in that site, or a URL in the manufacturer's web site, or some other web site where the actual numbers may be retrieved, or any other patent marking link.

Applied to Intellectual Products Having No Tangible Identity or Packaging

For use with products such as electronically distributed software, music, intellectual property or other intangibles which have no physical existence and no physical packaging which is susceptible of patent marking, the patent-product data may be employed to give the best possible patent marking notice. Such notice may include specific patent numbers if limited in number, or a patent marking link, presented in a way that the public is most likely to see the notice. On software or firmware, e.g., the patent marking notice may be caused to appear upon installation, boot-up, on command, in response to a search command, as a pop-up when a product description or identifier or pictorial is viewed or mouse-clicked, in a site map, and in various other ways.

Applied After Product Purchase or Distribution

As will be described, patent marking may be applied after the product is distributed or purchased. According to case law in the United States, the patent marking, while not legally effective at the time of product purchase or distribution in this fact situation, will be effective beginning with the date of application of the patent marking on the product, so long as the marking is substantially consistent and continuous thereafter.

Patent Marking Updated After Distribution

In accordance with an aspect of the present invention, patent marking updates are distributed by the patent marking service to maintain patent marking current with the latest patent issues.

Rather than the patent-product data being delivered to the end user directly over wireless or wireline communications link, as will be detailed below, the data may be delivered on storage media along with search software if and as needed. The patent-product data may be “pulled” from the patent marking service database by a user query or “pushed” to the user as by an auto update service. The update service would typically be employed to update a client's or user's database when a new patent has issued which is relevant to previously expressed patent marking data query. The storage media may take a variety of forms, including CD or other optical media, floppy disk, tape or other magnetic media, flash card or other solid state media, RFID (radio frequency identification) tag, label or other media, bar code (particularly a two-dimensional or three-dimensional bar code), or other storage media. As discussed below, the user is facilitated by these data storage products to retrieve the needed patent marking data from the provided storage.

FIGS. 1A-1F identify schematically a number of the processes of the invention which are encompassed under the heading “Patent Retrieval Service” 30 in FIG. 1. The following description will be a general description, further details being given in the description of specific executions below.

### Execution No. 1

In the FIG. 1A patent retrieval execution, patent data, including patent numbers, are delivered, preferably by download, to the client 21. The client may be internal (in the same organization as the patent marking service) or external, but typically is a manufacturer or assembler of products. The download may be on manual, semi-automated or fully automated command from the client, or may be “pushed” to the client as in the case of an update service. The patent data will typically have been culled or categorized for application to a particular product, part or feature, but can be more broad based, with the client accepting the task of any further screening or pruning of patent numbers before application to the product.

The client applies the patent data to the product. This can take place as part of a fully automated or semi-automated production control process, or can be manual. The patent data may be applied through labeling, screening, machining, molding, or other physical process to the product or its package, or may be loaded into firnware, embedded in software, printed in manuals, or otherwise made known to the public.

In the FIG. 1A execution, the public typically retrieves the patent numbers by simply observing them on the product or its packaging.

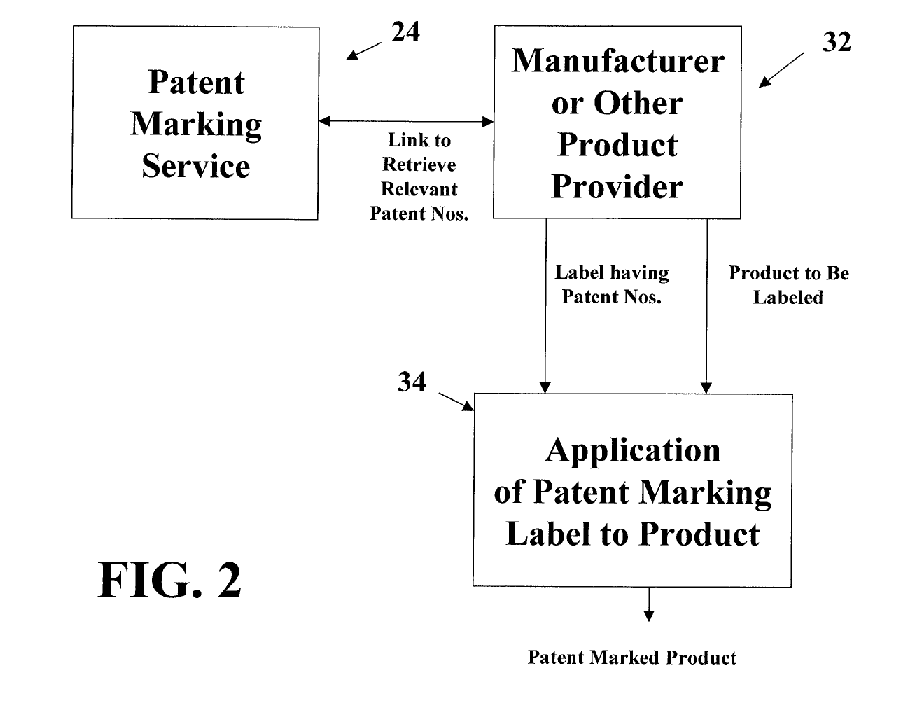

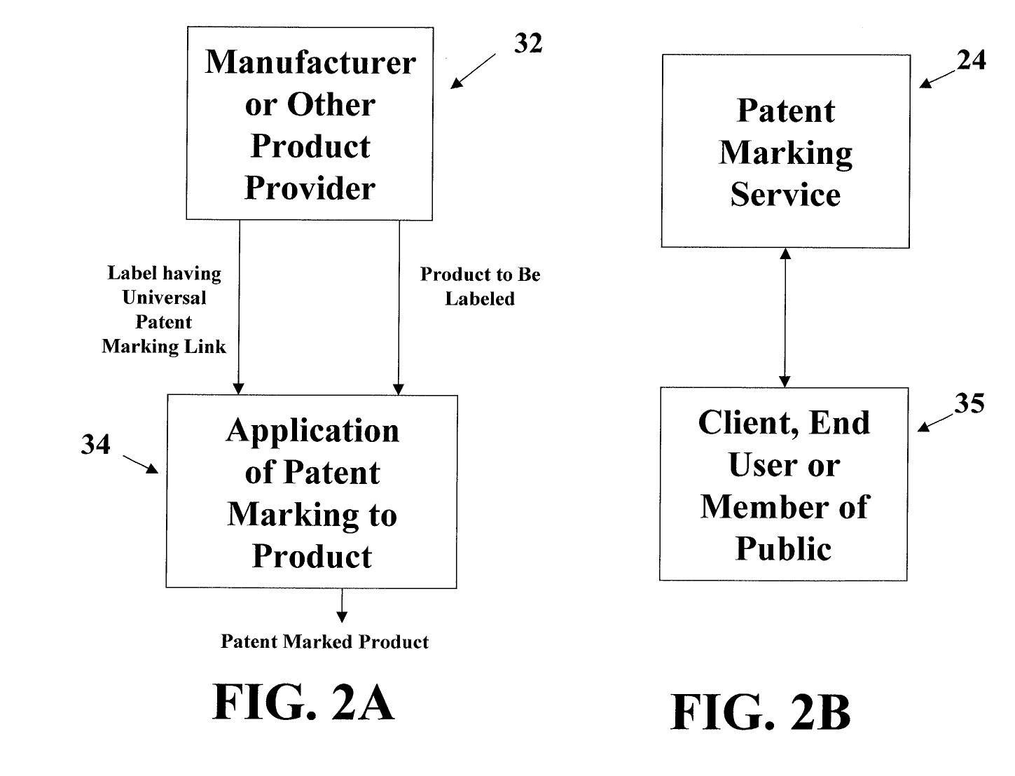

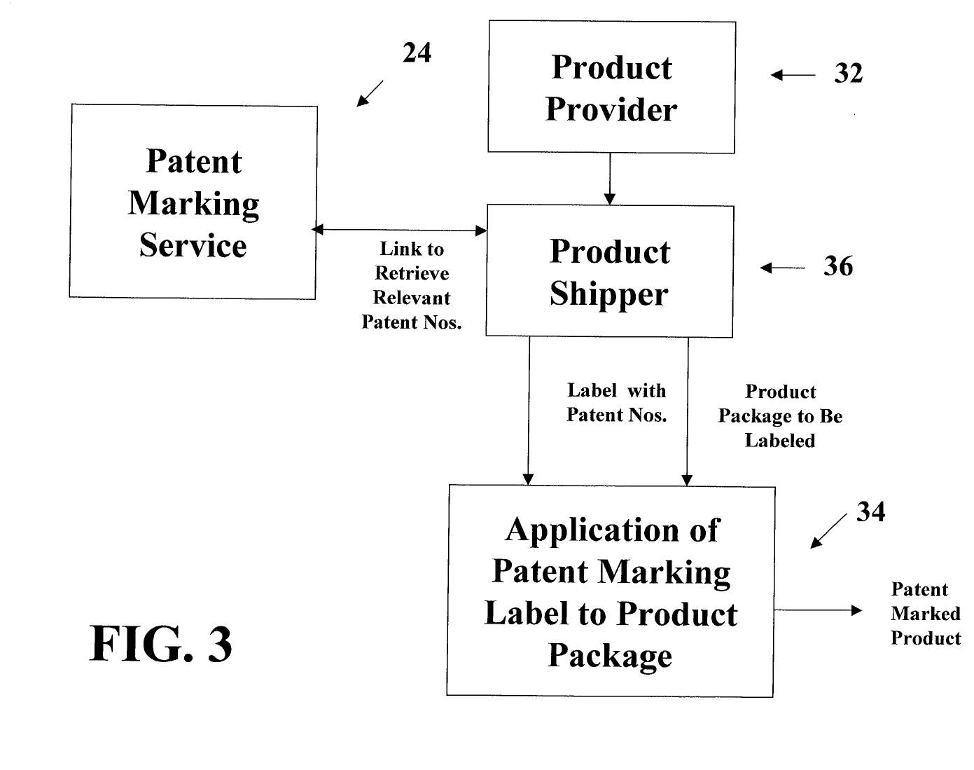

Refer to the FIG. 2 execution described below which is an elaboration of an execution particularly adapted for use by a client (a manufacturer or assembler, for example) having an ERP (enterprise resource planning) or other automated production control system which automatically applies to patented products patent data retrieved from a patent marking service. Also refer to the FIG. 3 execution described below wherein the client is a shipper, rather than a manufacturer, for example.

### Execution No. 2

The FIG. 1B execution is similar to the FIG. 1A execution, except that the patent data is coded to be machine-readable. This may be accomplished by the use of bar codes, RFID (radio frequency identification) or other such techniques, as will be explained in detail below. The coded patent data is applied to the product or its package. For bar codes, application can be through a label, tag, ticket or card or direct printing, for example. Here follows a brief description of bar coding technology.

What once seemed to be simply an odd little zebra stripe that began appearing on a few retail food-industry goods in the early 1970's has evolved into an effective and widely used productivity enhancement tool. Bar codes are a fast, easy and accurate data entry method used in the process known as automatic data collection. Bar coding enables products to be tracked efficiently and accurately at speeds not possible using manual data entry systems. The primary benefit of this process is that it is automatic, occurring instantaneously as a transaction or process takes place, commonly referred to as real-time data capture and exchange. Improved accuracy is yet another benefit.

The IBM PC explosion in the early 1980's, served as the catalyst to promote the widespread usage and application of bar coding for automatic data collection. Over the past 20 years, bar coding has become a virtual necessity for the collection and processing of information in a quick and timely manner enabling companies, in every conceivable industry, to maximize and dramatically increase their productivity and overall efficiency. Bar codes enable managers to track information and activity as it occurs allowing their decisions to be dictated by more concrete, current information.

Bar coding is a type of Morse code used to encode or put information into a universally recognized code language in the form of a bar code symbology. Typical encoded data consists of a part number, serial number, supplier number, quantity, transaction code, or other type of data. A number of bar code standards have been developed and refined over the years into accepted languages called symbologies. Numerous bar code trade associations, like (ANSI) American National Standards Institute, (HIBC) Health Industry Bar Code Council and (AIAG) Automotive Industry Action Group, have subsequently been established to regulate the use of bar code symbologies in accordance with accepted industry standards and specifications, as dictated by an industry.

Bar code symbologies come in two basic varieties. They can be either linear or two dimensional in their configuration. A linear barcode symbology consists of a single row of dark lines and white spaces of varying but specified width and height, as shown in FIG. 1B-1. Similarly, a two-dimensional symbology can be configured into a stacked or matrix format, as shown in FIGS. 1B-2 and 1B-3. Two-dimensional bar codes are special rectangular codes, which ‘stack’ information in a manner allowing for more information storage in a smaller amount of space. The amount of data that can be encoded in a linear barcode symbology is more limited than that of a 2-D symbology. A 2-D matrix symbology of 1×1 inch diameter, for example, can encode and store the entire US Constitution.

To establish a basic bar code system for automatic data collection, four primary components are required. They are—a bar code printer, a label for item tracking, scanning equipment for data collection and an external database for bar code data capture and relay.

Component 1—The Bar Code Printer The bar code printer provides the first vital component part in tracking information by generating the bar code label utilized in item tracking. A variety of technologies and methods exist to print a bar code label.

Component 2—The Bar Code Label Automatic identification is the essential first step in a barcode system which is accomplished by attaching a barcode label to an item for tracking. An item label can contain any combination of text, graphic or bar code information, yet it is the bar code symbology that facilitates and promotes the item tracking process.

Component 3—Scanning Equipment for Data Collection The data collection phase occurs through the use of scanners that instantly and accurately read, capture and decipher the information contained in the barcode label. Scanners read information much faster and more reliably than humans can write or type, thus significantly reducing the rate or likelihood of error. Scanners also act as decoders deciphering the information contained in the barcode and converting it into a signal that can be understood by a computer system attached to a scanner. Print quality is of utmost importance when printing bar codes so that the scanner has the ability to read them.

Component 4—Data Capture via an External Database The fourth component to establishing a bar code system is the external database. Existing barcode applications commonly rely on the availability of external data computer systems to effectively identify a unique bar code with pertinent information about the article from a related database. The computer mainframe collects and interprets the data transmitted from the scanner and links the bar code reference point information to a detailed data file on that item. Such data files commonly contain various information on the item, including but not limited to, a detailed product description or price and inventory quantity, to enable transactions and activity to be effectively monitored in real-time. Without the advent of this external database, the bar code itself has no useful meaning or problem solving significance.

Thus linear bar codes have the storage capacity to store a number of patent numbers. Two-dimensional bar codes, and recently, bar codes which use color as a third dimension, have adequate storage capacity to store dozens, or even hundreds of patent numbers and additional patent data. Bar code printing and reading equipment is readily available in businesses today, making patent marking via bar coding a viable way to give constructive notice to the public of patent data relevant to a particular product, feature, or component. It is an aspect of this invention to use bar codes or other machine-readable codes for the purpose of giving constructive notice of relevant patents in accordance with the laws governing patent marking. Bar code labels can, in accordance with this invention, display relevant patent data in machine-readable form (bar codes) and concurrently print the appropriate numbers on the label in alphanumeric form for visual retrieval.

RFID technology can also be employed as a way to patent mark products within the ambit of the patent marking laws. RFID technology is well known; principles are described, for example, in the text, RFID HANDBOOK by Klaus Finkenzeller, John Wiley & Son, copyright 1998. A brief description of RFID technology follows.

RFID systems are intended to carry data in suitable transponders. An RFID transponder is shown schematically in FIG. 1B-4, comprising in its most basic form an antenna 39 which may be inductive or capacitive, and a semiconductor chip. Data within a transponder typically provides identification for an item in manufacture, goods in transit, a location, identity of a vehicle, an animal or individual. An RFID system requires, in addition to transponders, a means of reading or interrogating the transponders and some means of communicating the data to a host computer or information management system. A system will also include a means for entering or programming data into the transponders. Data is communicated between transponders and a reader wirelessly. A transponder comprises a microchip containing a memory in which data is stored. An antenna, which may be inductive or capacitive, is coupled to the radiated field of the reader in the nature of a transformer in “near field” conditions, or acts as a radar antenna in “far field” applications. The reader sends data to and receives data from the transponders through its antenna and receiving circuitry.

Bar code and RFID technologies offer ideal mechanisms to provide patent marking information to the public, which in practical terms means to the business community. Businesses today all employ extensive bar coding, and RFID is rapidly being adopted as a companion, and in some cases as a replacement, for bar coding.

These technologies have the needed memory capacity, and importantly, comprise components of digital data processing systems which permit automated machine acquisition, processing, updating, recording, reproduction and utilization of patent marking data. It is an aspect of the present invention to use RFID technology to accomplish patent marking in accordance with the laws governing patent marking.

FIG. 1B-5 illustrates a label 43, which may also be a ticket, tag, card or other media, or an actual product or product package, with a combination of patent markings thereon. The label 43 has a bar code 45 of the high-capacity 2D type which is encoded such that when read, it generates digital data identifying at least one or more patent numbers relevant in a patent marking sense to the product to which it will be ultimately applied. An RFID transponder 49 may contain the same information, supplemented (due to its very much greater capacity) with additional bibliographic or other information related to the patents pertaining to the product to which the label will be applied, or other data unrelated to patent marking. Additionally, as shown at 47, patent data may also be printed in human-readable form on the label. Finally, still further patent marking data relevant to the product to which the label 43 is to be applied is indicated to be available at URL www.patentmarking.com, the web site address of a patent marking service operated by the patent owner, or a for-profit or not-for-profit service organization serving the patent owner and other clients. Normally, it would not be necessary to duplicate patent marking information, as shown with respect to label 43, however in certain applications the information can be more complementary than redundant.

### Execution No. 3

The FIG. 1C execution involves indirect patent marking of the product or package. The client 21 applies to its products or product packages a link to the patent marking service 30. As will be explained in great detail, the link typically identifies a web page or other online address of the patent marking service employed by the client, internally or externally, through which service the specific numbers of the patents covering the marked product, component or feature can be ascertained.

The public 25 observes the link on the product, and accesses the patent marking service 30 through the link to learn the numbers of the patents pertaining to the marked product. Any member of the public, upon seeing such a patent marking notice, if desiring to imitate the product or any part thereof, is legally obligated to make a reasonable effort to pursue the notification by accessing the indicated URL and the instructions it provides on how to obtain the patent number(s) of the product or product part or feature which is of interest.

Refer to the FIGS. 2A and 2B execution described below which is an elaboration of an execution particularly adapted for use by clients having large numbers of patents and products. Such clients typically desire to apply a single universal patent marking legend to all products in the form of a link to a patent marking service where the relevant patent numbers can be retrieved.

### Execution No. 4

The execution of FIG. 1D is similar to the FIG. 1C execution except that the link is a machine-readable code. This may be accomplished through a bar code, RFID code or other such means, as explained above. In this execution, the simple act of reading the code will create an automatic hot linking to the patent marking service. The result may be as simple as a table, list or hierarchical tree which identifies for the user the numbers of patents, and optionally additional information, which are relevant to certain components, features, methods or other improvements of the marked product.

### Execution No. 5

The FIG. 1E execution has the patent marking service 30 delivering the patent data, not through a download, but on digital storage media such as a CD-ROM, floppy disk, semiconductor memory, or other storage media. In this application the patent data will typically have been categorized by the patent marking service for the particular products to be marked. The client 21 includes a copy of the CD-ROM in each product package, for example, or otherwise causes the media to be associated with the product in a patent marking sense.

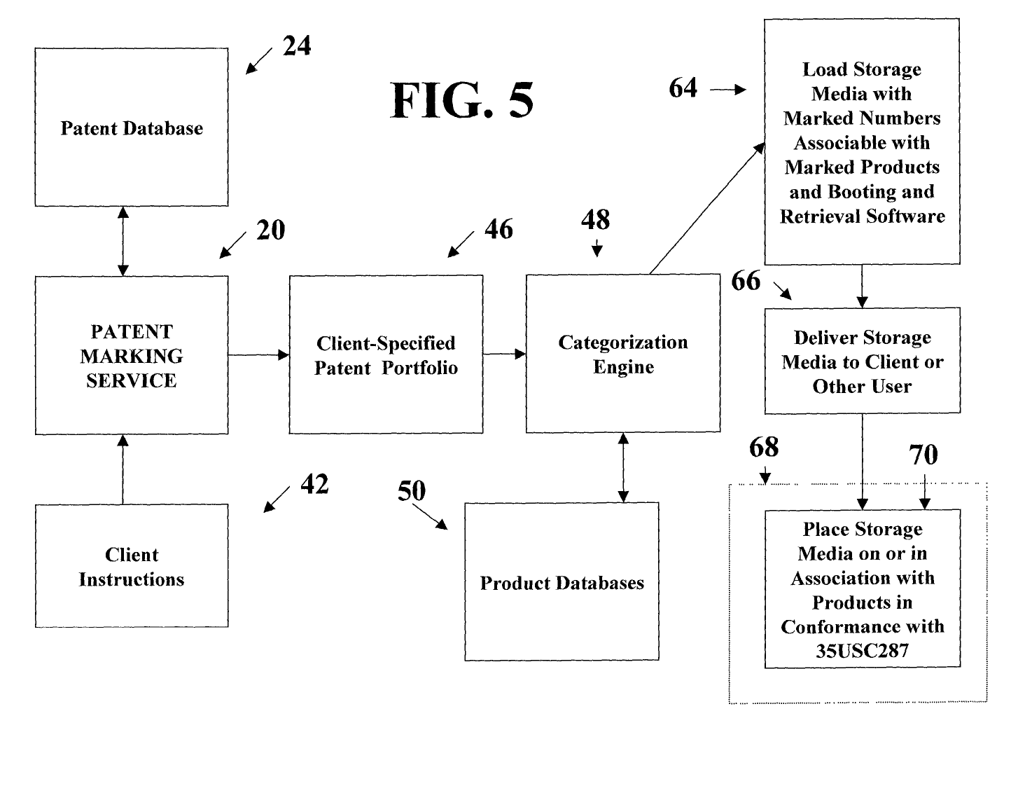

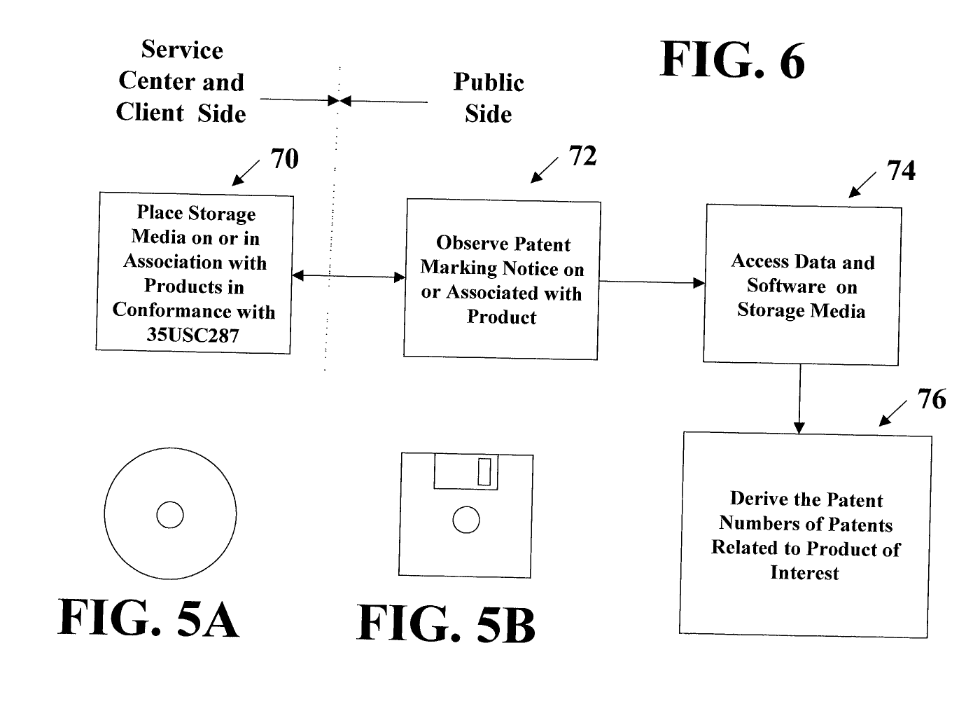

The public 25, upon possession of the product, simply loads the media in a computer or other reader 29 and retrieves the patent numbers, and optionally additional data, relevant to the marked product. See also the discussion of Execution No. 12 below depicted in FIGS. 5 and 6.

### Execution No. 6

The FIG. 1F execution is similar to the FIG. 1E execution with one very significant difference. In the FIG. 1F execution, the storage media contains not just patent data, but is also bootable and has a search capability. This permits a manufacturer, for example, to prepare one storage media containing patent-product data for all of its products. The search capability inherent on each disk guides the public to the particular product, component, feature or other improvement of interest. By this approach, the storage media becomes universal. One patent marking media is usable with all products of a company, for example, very significantly reducing the cost normally associated with identifying specific sets of patent numbers for different products or product families, and tracking which set goes with which product or product family.

To retrieve the patent numbers of interest, the public 25 installs the media in a computer, and uses the included search software to locate the numbers of the patents which relate to the product, component or feature of interest.

### Execution No. 7

FIG. 2 depicts an execution of the present invention which is an elaboration of the FIG. 1 execution described above. The user (client) of the patent-product data is a manufacturer, assembler or other provider of products (32 in FIG. 2), for example, which applies the patent marking notice to the product. The manufacturer typically will have its production management system integrated into an ERP (enterprise resource planning) system such as SAP, Baan, J. D. Edwards or Oracle, or a proprietary production management system. The patent marking service has in a local, or an accessible remote, patent database a collection of at least all of the patents of the manufacturer and all subsidiaries and affiliated companies which it desires to patent mark on its products. Assuming the manufacturer to use product labels to carry its patent marking notice, the production management system is programmed to include a link to the patent marking service for the numbers of patents relevant to the particular product before the label printer is commanded to print the product label with patent marking notice, or separate patent marking label. The production management system supplies to the patent marking service a relevant product identifier such as a model number, part number, brand name, trademark, perceived USPTO and WIPO patent classification subclasses relevant to the camera's various technologies, product description, UPC code, or the like, or a special patent marking code. The patent marking service will preferably have a lookup table or patent-product correlations otherwise stored which contains required the information. The lookup table or correlations created offline would have been automatically or manually updated with the latest patents issued to the manufacturer.

If the patent-product data called for is not available in a lookup table or other stored correlation, the patent marking service will develop the needed patent-product correlation data or map in real time using the processes described above. The patent-product data is supplied by the patent marking system for refreshing a system memory, or may be utilized directly by the production management system.

The production management system utilizes the patent-product data to produce a label containing the relevant patent numbers and a relevant caption or legend such as “Manufactured under Patent Nos. XXX”, or simply “Patent Nos. XXX”, where “XXX” is a list of one or more patent numbers (See FIG. 2). The product to be labeled and the label are brought together and the label is applied (34 in FIG. 2). The output is a product having patent markings meeting the requirements of 35USC287.

The patent-product data may be employed not just to print patent numbers on a label. Alternatively the data can be loaded into firmware, embedded in software, used to print a patent marking notice in manuals, or to direct print a patent marking notice on cartons or packages, or employed in a variety of other ways, as one skilled in the art will readily recognize.

Rather than having the patent-product data downloaded or accessed automatically, it can be retrieved one at a time manually, or in various semi-automated processes.

As described above with reference to FIG. 1B, if alphanumeric text is not feasible or desired, as described above with respect to the product provider, the product provider may apply a coded patent marking in the form, e.g., of a bar code or radio frequency identification (RFID) transponder. The bar code may be of the two-dimensional type which UPS employs or a newer three-dimensional type known as Color Ultracode developed by Zebra Technologies Corporation of Vernon Hills, Ill. in order to hold the necessary volume of data. Bar code and RFID readers are readily available today.

### Execution No. 8

FIGS. 2A and 2B depict a variant of the present invention introduced broadly in the above discussion of the FIG. 1C execution, wherein an indirect patent marking, rather than a direct patent marking is employed. If the product is a computer chip or other device too small to receive a number of patent numbers, for example, or direct patent marking is otherwise not practicable, the production management system (or a manual or semi-automated system) may cause to be applied to the patent marking label, as the best patent marking notice possible under the imposed conditions, an indirect patent marking in the form of a patent marking link. In a preferred arrangement the patent marking link may take the form of a URL legend such as “For patent marking data, see www.patentmarking.com”.

As indicated schematically in FIG. 2B, any client, competitor, product end user, or other member of the public 35, seeing the patent marking link and desiring to learn what patents cover the computer chip (in this example), can simply access on the Internet www.patentmarking.com which is (in this hypothetical) the home page or other page of the web site of the patent marking service. The patent marking service has a graphic user interface which guides the user to the information desired. As described, the patent marking service may have a lookup table or otherwise have correlated the desired patent-product data off-line. If not, the user's query will trigger the categorization engine 28 (FIG. 1) to develop the desired information in real time.

In a preferred execution of the invention, the user or other member of the public 35, upon request, will be supplied not only the relevant patent numbers, but also additional bibliographical data and a digital copy of the patent. With the full digital patent available from the patent marking service, the user's ability to ascertain whether the manufacturer has patents relevant to the user's interest is expedited.

### Execution No. 9

FIG. 3 depicts another execution of the method of the invention which was introduced above in connection with the FIG. 1A execution. FIG. 3 also has functions in common with earlier descriptions of the methods, and those are given like reference numbers. In the FIG. 3 application the manufacturer ships all of its patented products by a selected one or more highly automated shippers such as UPS (United Parcel Service) or Federal Express, and has contracted its patent marking function to its shipper(s). In this arrangement, the shipper 36, rather than the product provider (typically the manufacturer or assembler) 32, retrieves the patent-product data from the patent marking service. The shipper will have, or can be given by the product provider 32, the product identifier(s) needed to retrieve from the patent marking service the appropriate patent numbers. It programs its information management system with that data.

Having accessed the patent marking service and retrieved the appropriate patent-product data for the product being shipped, that data is applied in alphanumeric text to the external shipping label which the shipper applies to an external surface of the product being shipped. As described, if alphanumeric text is not feasible or desired, as described above, the shipper may apply a coded patent marking in the form, e.g., of a bar code or radio frequency identification (RFID) label, or other coded marking. As shown in FIG. 3, the output from the described process is a label bearing the patent marking data which is applied to the product package to be labeled (34 in FIG. 3).

Rather than a label, the marking (including coded) may be by direct printing on the package, or application or injection of an RFID transponder into the package, or other form of marking.

### Execution No. 10

In another variant of the invention similar to FIGS. 2A and 2B, a shipper may apply an indirect patent marking, rather than a direct patent marking. If the product package is too small to receive a label with a number of patent numbers, or direct patent marking is otherwise not practicable or desirable, the shipper may cause to be applied to the patent marking label or directly to the package, as the best patent marking notice possible under the imposed conditions, a patent marking link. As described above with respect to FIG. 2B, any member of the public, seeing the patent marking link and desiring to learn what patents cover the packaged product, can simply access the marked patent marking link. The patent marking link may be coded, as described.

### Execution No. 11

An execution somewhat akin to the FIG. 1C will now be described in which a member of the public receives a patent marking notice through application of a URL or other patent marking link on a product. The link directs the public, not to the patent marking service, but, in a preferred arrangement, to the client's own web site.

In this variant the patent marking service 20 may be an in-house function, or alternatively may be an outside service. The patent database 24 may reside on the client's own in-house patent database management system, or may be a public patent database which the patent marking service avails like any other member of the public.

The client 21 (in this case an internal function) applies a link to the client's products 23 in the form of a URL representing the home page or a subdirectory page of the client's own web site. To retrieve relevant patent data from the link, the interested member of the public 25 accesses the link on the Internet and is taken to a page on the client's web site. On that page, or set of pages, is a table, chart or other patent-product map which displays the patent numbers relevant to the marked product of interest to the member of the public. This execution is most suitable in applications where the number of client products and patents is not so excessive that a lookup table approach is not burdensome to the public.

In this execution of the invention, if the private entity or client 21 were ABC Camera, e.g., it would mark its products with a notice such as “For 35USC287 patent marking notice, go to www.ABCCamera.com/patentmarking.html” which would guide the user to a subdirectory of ABC Camera's web site home page. On that page, the user would be guided to the patent(s) which relate to particular products, components or product features by a simple list, or any of a variety of other presentations, as described above. The arrangement described in the last two paragraphs are equally applicable to other executions described herein.

The following scenarios will aid in an understanding of certain executions of the invention in use, and its many benefits over existing patent marking practices. In this example, the product of interest is the ABC Camera D-100 digital camera, and the public user, likely a competitor of ABC Camera, would like to know what patents ABC Camera holds, if any, on the lens system for the camera. In this hypothetical variant we deviate and say that ABC Camera has employed the services of PatentMarking.com, an in-house patent marking service of the type described herein. The user reviews a D-100 camera that it has purchased, looking for patent marking information. It finds a legend prominently marked on the product, its packaging, user manual and software presentation upon start-up, which clearly indicates that the user can identify patents covering the camera and its components by accessing URL www.patentmarking.com. In a first scenario ABC Camera has provided to PatentMarking.com various look-up tables cross-correlating the patents it holds on the D-100 camera, including five patents on the lens design, to one or more of the following D-100's descriptors: model number (“D-100”), various serial numbers, a list of part numbers, brand name, perceived USPTO and WIPO patent classification subclasses relevant to the camera's various technologies, and a thesaurus of relevant keywords.

The user accesses URL www.patentmarking.com with a computer, handheld or other wired or wireless Internet access device, using keyboard, voice, mouse, pen, touch panel or other input-output facility, and is presented with a menu-driven graphic user interface.

The menu asks that certain descriptors of the D-100 be entered (model number, for example), and keywords or other identifiers describing more particularly a component or feature of interest. The user enters model number “D-100” and keyword “lens”. The system responds by interrogating the relevant model number and keyword look-up tables, and presents a list of the numbers of the five patents which ABC Camera holds specifically related to the camera's lens design.

The menu asks whether the user would like to see also front page patent information, or a full text of the patent. The user responds by requesting that a full text of the five patents be downloaded to a named file on a storage device, or that the data be emailed. The transmitted patents have the word “lens” highlighted wherever it appears in the text of the patents.

In a second scenario ABC Camera has not provided any patent-product data to PatentMarking.com, in which case the processing system of PatentMarking.com may not have archived appropriate patent-product correlations and therefore develops the patent-product map in real time employing the categorization methods described herein. The output patent numbers are preferably relevance ranked to aid the user in reviewing the list. If the list is excessively long, the system, through a threshold set by the user or by the patent marking service, may delete patents whose relevance is deemed so low as to not merit review. Alternatively, the user may use its judgement as to where on the list to discontinue in-depth review.

Reiterating, suppose the patent marking entity has only three products and fifteen patents relating to those products. It may not wish to retain a patent marking service, but rather to simply have a page on its corporate web site where it lists the numbers of its patents and the product or products to which they relate. In that scenario the patent marking link that would be marked on its products, packages, etc. can be the URL of the said web page on its corporate web site. For example, following the above example, if ABC Camera were to bring the service in-house, it might have a web page www.ABC Camera.com/patentmarking.html on which would be displayed its various patents categorized by subject matter. Or, it may employ one or more of the described categorization tools.

In applications where the numbers of marked products and related patents is limited, the retrieved information may simply be a patent marking legend of the type conventionally employed today, such as “Under or for use with U.S. Pat. Nos. X,XXX,XXX; Y,YYY,YYY; and Z,ZZZ,ZZZ.”

In the executions described above, the patent portfolio (46 in FIG. 4) is located remotely from the product being patent marked, and is accessed through a wired or wireless communication link. Other executions of the invention will now be described wherein the patent portfolio is resident on or in association with the product being marked.

### Execution No. 12

FIGS. 5-6 illustrate another execution of the principles of the present invention which represents an elaboration of the execution described above in connection with FIG. 1F. In the FIGS. 5-6 execution the patent data and all or a part of the associated retrieval and booting software are stored on movable or stationary storage media such as a floppy disk (FIG. 5B) or other magnetic disks or storage medium, CD-ROM, DVD or other optical disk or storage medium (see FIG. 5A), solid state storage or other storage media which is distributed by the client of the patent marking service with the marked products, or later brought into association with the products by the client or another.

A patent marking service 20, operating under instructions 42 from the client, and with access to patent database 24 develops a patent portfolio 46. The client patent portfolio 46 is supplied to categorization engine 48. The portfolio 46 data may comprise truncated, compressed, indexed, or tagged, or full-text content of the portfolio of patents. In the engine 48 the portfolio 46 is processed with data from product databases 50 in such a way that when loaded on storage media (step 64) with appropriate retrieval and booting software, a public user can obtain at least the numbers of the patents, if any, in the portfolio 46 which relate to the products of interest to him or her. The retrieval and booting software is of the well-known type which autoloads the programs and presents a menu-driven GUI to the user.

The result is a simple, quick, universal access to data on a portfolio of patents from which can be quickly and accurately abstracted by a user the numbers of one or more patents, if any, which relate to a specific product or feature of interest.

Continuing with a description of the FIGS. 5-6 execution, in step 66 the storage media with loaded content and software is delivered to the client. On the client side (indicated by dotted line 68) the final step 70 comprises the client placing the storage media on or in association with the products being marked in conformance with 35USC287.

FIG. 6 depicts the FIGS. 5-6 process as seen from the perspective of the public. A user locates the storage media (step 62) and observes the patent notice. The notice indicates to any interested member of the public that the storage media can be accessed to obtain the numbers of the patents, if any, which pertain to the product or feature of interest to the user.

If interested, the user accesses the data stored on the storage media through the use of a computer, handheld reader or other device capable of reading the storage media (step 74). A graphic user interface guides the user through a series of menus; the menus will vary depending upon the patent-product data desired. The user will follow the menu instructions (step 76), ultimately producing a list or “best list” of the patent number(s) which relate to the product of interest to him or her, as described above.

### Execution No. 13

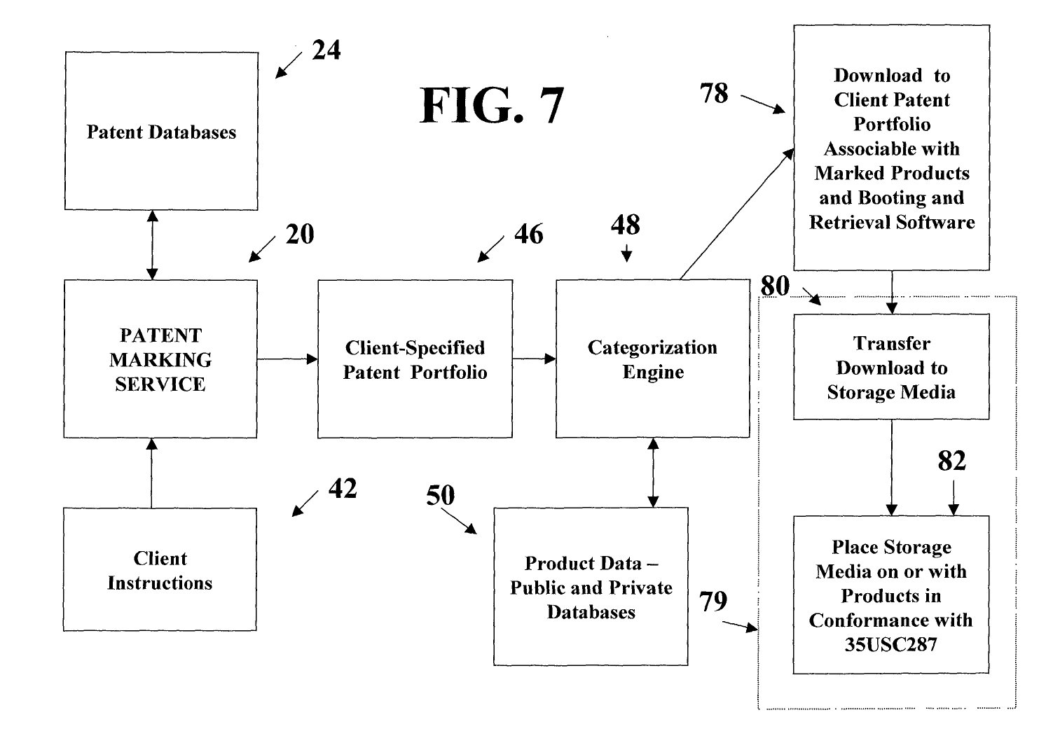

FIG. 7 is yet another execution of the present invention which is similar to the FIGS. 5-6 execution except that rather than the patent marking service producing the loaded storage media and delivering it to the client, here the data is downloaded or otherwise delivered or transmitted to the client (step 78) which transfers the data to storage media (step 80). The final step 82 of placing the storage media on or with products or other products is the same as in the FIGS. 5-6 execution. The end result is the same as in the FIGS. 5-6 execution.

A continuation of the ABC Camera digital camera scenarios given above may be useful in understanding the FIGS. 5-6 methods according to the invention. A scenario to be described is similar to the earlier-described scenario except that the user, rather than observing a patent marking link from which the marked patent numbers can be ascertained, a legend on the product or its package, or otherwise associated with the product in a way sufficient to satisfy the patent marking laws, states that the related patent numbers, if any, can be found by accessing a storage media containing the patent marking data. If the storage media is an optical disk, for example, the user loads the disk in a disk reader computer peripheral, for example. The disks self boots and the user is presented with a menu which can be readily followed to obtain the desired patent numbers, as described above. If the numbers of related patents and products is small, upon booting the storage media, the user may be presented with a simple list of the patents and the products they relate to, or a simple patent marking legend of the type used conventionally today, such as: “Under or for use with U.S. Pat. Nos. X,XXX,XXX; Y,YYY,YYY; and Z,ZZZ,ZZZ.”

### Execution No. 14

In other executions of the invention the storage media and associated software and hardware may be different than as described above with respect to FIGS. 5-7. The retrieval and booting software may be partitioned between the device containing the storage media and the device which retrieves the desired information.

### Execution No. 15

RFID technology may be employed, e.g., in patent marking applications where the patents are on life forms. For example, in an application where the life form is a patented sheep clone, embedded chip RFID transponder technology may be employed in accordance with this invention to provide a patent marking notice. Here, as noted, the patent marking data may relate only to patent numbers or other data respectively associated with the marked product (sheep). To retrieve the numbers of any patents relating to the sheep, the user would simply employ a commonly available RFID reader to obtain the numbers of the patents relevant to that life form. Embedded RFID transponders of the type described are now available to store pet identification data.

Certain RFID transponders are passive, not requiring batteries, but rather using the energy in the interrogating electromagnetic field generated by the reader to power the RFID response. Other RFID devices are active, utilizing a battery to power the transponder. The active devices may be used where longer range is desired, or where the RFID transmissions occur independently of an interrogation by a reader.

Readers employed with RFID devices typically have a visual display which in the application being discussed would be the patent numbers stored in the RFID memory. In an interactive application, the RFID transponder includes a data processor and means for receiving and responding to data-querying inputs. In this arrangement, the RFID memory can store unrelated patents as well as related patents, as those terms are used above, for example. With a suitably equipped reader, the user interacts with the transponder to derive selected patent numbers to the exclusion of others. The technique would thus be similar to that described above, but on a more modest, less sophisticated scale. The reader may reproduce the retrieved patent numbers as recorded or synthesized voice, or as a visual display or printout. The reader interrogation of the transponder may be by querying with an alphanumeric keyboard. Or the querying may be with a voice. The reader would recognize the voice commands and translate them to RFID signals for relay to the transponder. The interrogating may be accomplished locally with a direct connection, or remotely through an electromagnetic, optical or other wireless link.

### Execution No. 16

In accordance with another application of the present invention method, digital patent marking information is distributed for application to, or associating with, a product to which the information relates in a patent marking sense. The distributed digital patent marking information is thereafter updated. The patent marking updates may be distributed by email or a variety of other ways, but preferably they are distributed as a download on the Internet or other public or private network, or a private network. The patent marking updates include as a minimum patent numbers, but may include bibliographic or other information related to the patents.

As noted, the invention may be employed, for example, to correct gaps or inconsistent patent marking in a factory, using downloading of electronic patent marking notices into or in association with previously purchased/licensed products, or to the purchasers/licensees where downloading into or in association with the product is not practicable. The most common application of this execution of the invention, however, is to distribute to clients, public requesters or other parties having earlier received patent marking information patent marking information concerning patents which have issued since earlier information was distributed.

The updated patent marking information may be used to update a memory in a production management system, update electronic downloads to previous downloaded product purchasers, modify patent marking labels or other patent marking carriers or vehicles, update RFID transponders containing patent marking data, alter patent marking information downloaded into CD-ROMs, floppy disks or other stores of digital patent marking data distributed with a product, or used in countless other ways, as will be obvious to those skilled in the art who are familiar with the teachings set forth in this patent application.

### Execution No. 17

As noted above, patent marking may be applied after a product is distributed or purchased. According to case law in the United States, a patent marking, while not legally effective at the time of product purchase or distribution in this fact situation, will be effective beginning with the date of application of the patent marking on the product, so long as the marking is substantially consistent and continuous thereafter.

It is an aspect of the present invention to provide, distribute or make available patent marking information after a product is distributed to which the patent marking information relates in a patent marking sense. The patent marking information may take the form of coded or uncoded digital data, as described. The patent marking information is preferably distributed as a download on the Internet or other public or private network, but may be distributed also in the form of email. The patent marking information may be distributed as a label adapted to be applied to the product or its package. The patent marking information may include patent marking information about patents which issued before, as well as after, a product was distributed.

After-distributed patent marking information may be used to load or update a memory in a production management system, notify by electronic download previous downloaded product purchasers, originate or modify patent marking labels or other patent marking carriers or vehicles, load or update RFID transponders containing patent marking data, originate or alter patent marking information downloaded into CD-ROMs, floppy disks or other stores of digital patent marking data distributed with a product, or used in countless other ways, as will be obvious to those skilled in the art who are familiar with the teachings set forth in this patent application.

### Execution No. 18

In a number of the above-described executions, the entity accomplishing the patent marking according to the invention is a manufacturer or other provider of products or a shipper of such products, for example. One of the benefits of the invention inures in the licensing industry. A typical provision in patent license agreements requires that the licensee mark on its products or packages the number of the patent(s) which are covered by the license agreement.

The reason such patent marking by the licensee is required is that if the licensee fails to mark the patented products it distributes under the license agreement, that failure is attributed to the licensor. Thus a licensor's efforts to abide by the patent marking laws by fully and consistently marking all of its patented products which are distributed in commerce can be frustrated if the licensee fails to mark its products.

However, the licensee is often in an even more disadvantageous position to properly mark licensed products than is the licensor. By this invention, a licensee is able to mark the licensed products it distributes by accessing a patent marking service that the licensor has made arrangements with or employing the techniques of the present invention described herein. It is therefore intended that the specification and claims of this application embrace utilization of the invention by patent licensees as product providers.

### Execution No. 19

The principles of the invention are not limited to making full use of United States patent laws. Other countries have patent marking laws. It is within the scope of the present invention to use the techniques described to give constructive notice effective under the patent laws of foreign governments or governmental groups through treaty and the like. A U.S. manufacturer, for example, can avoid the hassle of trying to mark its products intended for export to Germany, for example, with the numbers of the German patents which are relevant to the products in a patent marking sense. If a patent marking service is employed to provide patent maps, as described, those maps can include foreign as well as U.S. patent through tie-ins with foreign patent database providers such as Derwent and Inpadoc. Upon reaching the German destination, a German citizen or company, e.g., can quickly learn the relevant patent numbers by reading them directly if they are marked in human readable format, or can decode them if in machine-readable format. If the marking is indirect, the URL or other patent marking link can be accessed, and the relevant patent numbers derived from the manufacturer's patent marking service in the manner described above.

The numbers of published patent applications, rather than or in addition to patent numbers, may also be marked using the teachings of the present invention in order that the patent marking entity may avail the future benefits of such marking.

Whereas the storage and retrieval technology described in FIGS. 5-7 may as pedestrian as compact disks accessed by CD drives on everyday personal computers and laptops, more state of the art technology may be employed.

The possible executions of the present invention are many beyond those described. The primary components of the various possible executions of the invention are one or more databases storing patents to be marked in digital form, products marked with a notice of the digital availability of related patent numbers, and processes for correlating the patent data and the products and making the results known to an interested public user. Here follows in outline forming both a summary of a number of the concepts described and other extensions not yet mentioned. It is not to be construed to limit in any way the scope of the foregoing discussion. These items can be combined and permuted to arrive at useful executions too numerous to discuss here. All such are within the ambit of the present invention.

A database of patents

1. Local to the product and/or remote

2. Full text and/or truncated or compressed

3. Tagged/indexed

4. Related and/or unrelated to an product

5. US and/or foreign

6. Passive/read-only or active/interactive

7. Provider is owner or non-owner of the marked patents

8. Read-only or editable

Identification of product

9. Non-specific or specific

a. Specific

i. Serial number

ii. Model number

iii. Part number

iv. Brand name

v. Code

b. Non-specific

i. Description of attributes

10. Availability

a. Made available

b. Must be located and retrieved

11. Location

a. Local to product

b. Remote from product

12. Provider

a. Owner

b. Non-owner

13. Storage

a. Read-only

b. Writeable/Editable

14. Communication

a. Transmits on cue

b. Transmitted periodically, sporadically or continuously

c. Doesn't transmit

Correlating instrumentality/process

15. Data acquisition

a. Passive—reads and retrieves only

i. Swipe (as bar code reader)

ii. Trigger transmission

b. Active—interactive with data

16. Location

a. Local to product

b. Remote from product

17. Connection

a. Wired

b. Wireless

18. Accessing party

a. User only

b. User through one or more intermediaries

19. Correlation conditions

a. Patent data

i. All undefined

ii. User-defined subset

iii. Machine-defined subset

b. Product

i. All undefined

ii. User-defined subset

iii. Machine-defined subset

c. Process

i. Manual

1. Swipe, trigger, etc

2. Interactive interrogation

a. Keywords

b. Natural language

ii. Automatic

1. Robot

2. Intelligent agent

Data Backup by patent marking service

In those applications described wherein patent marking data is accessed by a user from a URL or online database, the patent marking service will back up the entire database every day on optical disks or other permanent storage media, preferably during the night hours, to establish proof of the availability to the public of the patent marking data.

### Execution No. 20

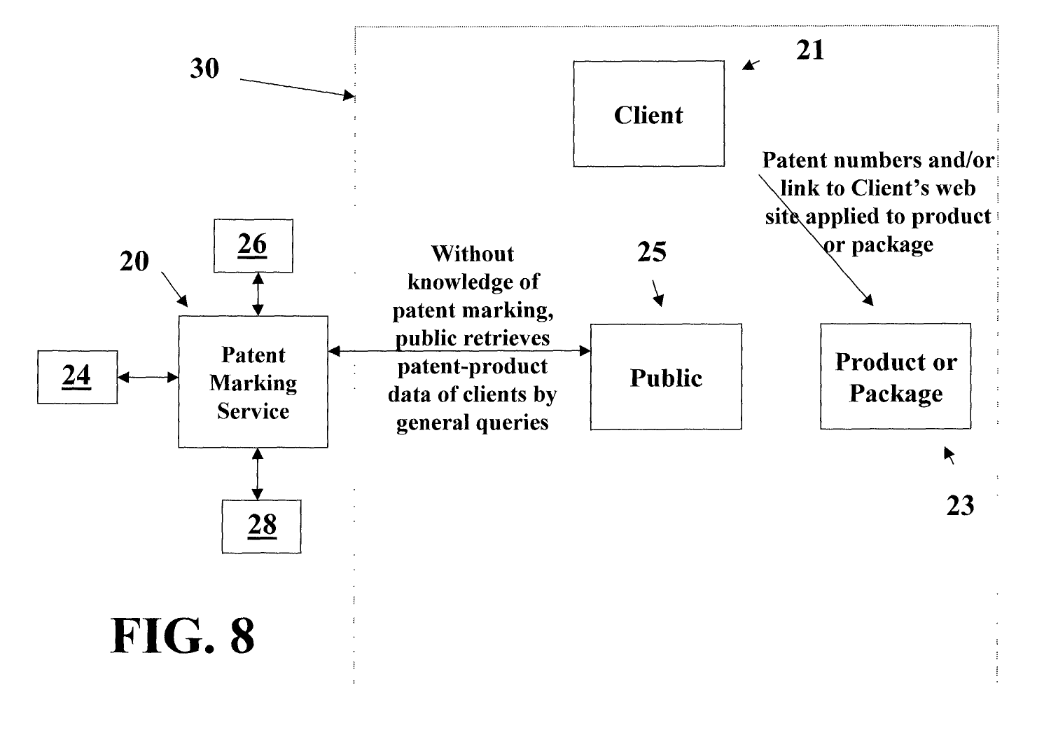

Yet another execution of the principles of the invention is illustrated in FIG. 8. This application arises at a time when the patent marking service 20 has accumulated a significant number of clients. The patent marking service has accumulated what amounts to a patent marking public library. The public will begin to query the patent marking service without knowing for sure whether a product of interest has been patent marked using the patent marking services, as taught by this invention. Constructive notice of patent coverage of a product is effective whether or not any member of the ever observes the notice. In a converse sense, the FIG. 8 execution permits a member of the public to learn of the existence of an act of patent without ever having personally observed it.

The availability of the patent marking service to serve the public and its clients in this way serves a number of purposes which inure to the benefit of clients and the public. First, the public can learn whether the technology underlying a specific patent is viable by accessing the patent marking service with the patent number and determining whether it has been marked on a product. This information can be valuable as part of pre-licensing, pre-purchase, or M&A due diligence. Second, a client can readily learn the percentage of its total portfolio which was being used to protect products.

Third, competitors or other members of the public can use the patent-product maps and correlations developed or developable by the patent marking service as a form of competitive intelligence. This can be accomplished by inputting to the service descriptors of various competitor products, or components or features of competitor products, and quickly learn which are patent marked, and if so with what patent numbers.

Having its patent marking data generally available to the public will benefit clients by enhancing knowledge of investors, customers and others of the advanced patented technology possessed by the clients. Further, the ready availability of knowledge of which products are patented and under which patents will significantly enhance the “scare-off” value of clients patents, thereby lessening competition and future disputes.

While particular embodiments of the present invention have been shown and described, it will be obvious to those skilled in the art that other changes and modifications may be made without departing from the invention in its broader aspects. The appended claims are intended to cover all such changes and modifications that fall within the scope of the invention.

I claim:

1. An improved method of patent marking products, comprising:
a. providing digital data identifying one or more patents related to predetermined products in patent marking sense; and
b. facilitating access to said digital data such that at least the numbers of said one or more related patents can be ascertained.

2. The method defined by claim 1 wherein said digital data identifying one or more patents comprises a portfolio of patents including unrelated patents which would not be appropriate to associate with said products in patent marking sense, and wherein said facilitating access includes providing a process for identifying in said portfolio said one or more related patents.

3. The method defined by claim 2 wherein said process includes relevance querying of said portfolio to identify one or more of said related patents.

4. The method defined by claim 3 wherein said relevance querying is performed by surveying the classification of the patents in the portfolio.

5. The method defined by claim 3 wherein said relevance querying is performed by surveying keywords in the patents in the portfolio.

6. The method defined by claim 3 wherein said relevance querying is performed by the use of a look-up table that correlates certain words or terms with certain the patents in the portfolio.

7. The method defined by claim 6 wherein said word or term comprises a model number, Universal Product Code, part number, serial number, brand name, trademark, technical classification or keyword.

8. The method defined by claim 2 wherein said method includes interactively identifying said related patents.

9. The method defined by claim 2 wherein said method includes said related patents being identified by an intermediary on behalf of an end user.

10. The method defined by claim 9 wherein said intermediary is a patent marking service.

11. The method defined by claim 10 wherein said patent marking service is maintained by the owner of the patents being marked.

12. The method defined by claim 10 wherein said patent marking service is maintained by an organization independent of the owner of the patents being marked.

13. The method defined by claim 1 wherein said digital data represents a specific set of patents that are all related to said products in patent marking sense.

14. The method defined by claim 13 wherein said process includes retrieving said digital data to identify said numbers of said one or more patents.

15. The method defined by claim 13 wherein said digital data identifying one or more related patents is located on storage media in a device which is located in, on, or associated with said products in a way which meets the patent marking laws.

16. The method defined by claim 15 wherein said storage media is moveable or stationary and is optical, magnetic or solid state memory.

17. The method defined by claim 16 wherein said storage media is a bar or other type code, and wherein said providing access includes reading said code with a code reader to ascertain said numbers of said related patents.

18. The method defined by claim 16 wherein said storage media is an embedded semiconductor chip.

19. The method defined by claim 18 wherein said process includes reading said embedded chip with a chip reader to ascertain said numbers of said related patents.

20. The method defined by claim 16 wherein said storage media is passive, and wherein said providing access includes retrieving said patent numbers therefrom with a reader.

21. The method defined by claim 15 wherein said device includes a data processor and means for receiving and responding to data-querying inputs.

22. The method defined by claim 21 wherein said providing access comprises the public user interrogating said storage device to retrieve said numbers of said related patents.

23. The method defined by claim 22 wherein said device responds to said interrogating with a visual display.

24. The method defined by claim 22 wherein said device responds to said interrogating with a synthesized voice indicating the said patent numbers.

25. The method defined by claim 22 wherein said device responds to said interrogating with an electronic signal carrying information indicative of said patent numbers.

26. The method defined by claim 22 wherein said interrogating comprises initiating a trigger signal which causes said storage device to automatically present information indicative of said patent numbers.

27. The method defined by claim 22 wherein said interrogating comprises querying with an alphanumeric keyboard.

28. The method defined by claim 22 wherein said interrogating comprises querying with a voice an d said storage media includes voice recognition means.

29. The method defined by claim 22 wherein said interrogating is accomplished remotely through a wireless link.

30. The method defined by claim 1 wherein said digital data identifying one or more patents is located remotely from the user, and wherein said providing access to said digital data is through an Internet URL or other public or private network address.

31. The method defined by claim 30 wherein said address is marked directly upon or associated with said products in a way that meets the patent marking laws.

32. The method defined by claim 30 wherein said providing access includes a patent marking service having an Internet URL or other public or private network address which is marked upon or associated with said products in a way which meets the patent marking laws, and wherein said patent marking service provides a menu-driven interface to retrieval software, enabling identification of the numbers of said related patents.

33. The method defined by claim 1 wherein said digital data identifying one or more patents is located on storage media that is located in, on, or associated with said products in a way that meets the patent marking laws.

34. The method defined by claim 33 wherein said storage media also includes booting and retrieval software effective to enable an interested party to retrieve said numbers.

35. The method defined by claim 33 wherein said storage media comprises optical media including compact disk and DVD.

36. The method defined by claim 33 wherein said storage media comprises floppy disks or other moveable magnetic media.

37. The method defined by 33 wherein said storage media comprises solid-state semiconductor memory.

38. The method defined by 1 wherein said providing access includes an intelligent agent or electronic robot capable of intelligently searching said digital data and retrieving at least the numbers of said related patents.

39. The method defined by 1 wherein facilitating access to patent information comprises providing an email address at which said patent information is stored, and employing an autoresponder which responds to queries with said patent number which relates to said set of products.

40. An improved method of patent marking products, comprising:
providing a database of patent information;
in response to a query for identification of patent numbers corresponding to a particular product or feature, accessing said database, retrieving said identification, and supplying said identification to the requester; and
utilizing said identification in association with said products in a patent marking sense.

41. The method defined by claim 40 including organizing said patent information in accordance with one or more predetermined product attributes in order to expedite said response to said query for identification of patent numbers.

42. The method defined by claim 41 wherein said organizing includes generating at least one lookup table.

43. The method defined by claim 42 wherein said lookup table correlates patent identification with one or more product attributes selected from the group consisting of: patent classification, market characteristic, brand name, part number, model number, technical description or keyword, serial number, universal product code, manufacturer, vendor or distributor.

44. The method defined by claim 40 wherein said organizing includes responding in real time to a request for identification by querying the database for patents which match prescribed attributes.

45. The method defined by claim 44 where said attributes are selected from the group consisting of: patent classification, market characteristic, brand name, trademark, part number, model number, technical description or classification or keyword, serial number, or Universal Product Code.

46. A patent marking method comprising:
acquiring or developing a patent-product map which correlates product attributes, identifiers or other product data regarding predetermined products with the numbers of patents which relate to said products in a patent marking sense; and
making said map available on a remotely accessible patent marking link such that upon accessing the link, patent marking information concerning the predetermined products can be obtained.

47. The method defined by claim 46 includes the step of placing upon or in association with at least predetermined ones of its patented products a patent marking including said patent marking link.

48. The method defined by claim 46 wherein said link comprises the URL of a page on a web site.

49. The method defined by claim 46 wherein said link comprises the email address of an autoresponder.

50. The method defined by claim 46 wherein said link comprises the telephone number of an online patent marking service.

51. The method defined by claim 46 wherein said link is maintained internally by said product provider.

52. The method defined by claim 46 wherein said link is maintained by an external patent marking service.

53. The method defined by claim 46 wherein said map is a manually developed lookup table.

54. A patent marking method comprising:
a. acquiring or developing patent-product maps which correlate, in a patent marking sense, product attributes, identifiers or other product data on products from a plurality of product providers with patent data associated with a plurality of patents from a plurality of patent owners, said patent data comprising at least the patent number; and
b. utilizing said maps to provide patent numbers correlated with products.

55. The method defined by claim 54 including the step of product providers placing upon at least predetermined ones of their patented products a patent marking link.

56. The method defined by claim 55 wherein said link comprises the URL of a page on a web site.

57. The method defined by claim 55 wherein said link comprises the email address of an autoresponder.

58. The method defined by claim 55 wherein said link comprises the telephone number of an online patent marking service.

59. The method defined by claim 55 wherein said link is maintained by a patent marking service.

60. The method defined by claim 54 wherein said maps are manually developed lookup tables.

61. The method defined by claim 54 wherein the maps are developed by:
accessing one or more local or remote product databases containing product data on the providers' products,
accessing one or more local or remote patent databases containing patent data characterizing a plurality of the providers' patents, said patent data comprising patent numbers, and one or more descriptors which characterize the respective patented inventions, at least one or more of said patents being relevant to one or more of said products in a patent marking sense, and
correlating said patent data with said product data.

62. The method defined by claim 54 wherein said utilizing comprises storing said patent numbers on storage media.

63. The method defined by claim 62 wherein said storage media is distributed with products related in a patent marking sense to the patents whose numbers are stored on said media.

64. The method defined by claim 63 wherein said distributing is accomplished by the provider of said products.

65. The method defined by claim 54 wherein said patent numbers are stored on storage media in machine-readable form.

66. A method comprising
a. accessing one or more local or remote product databases containing product data on products from a plurality of product providers, said product data including product attributes or identifiers associated with particular products;
b. accessing one or more local or remote patent databases containing patent data characterizing a plurality of patents from a plurality of patent owners, said patent data comprising patent number, patent owner, and one or more descriptors which characterize the respective patented inventions;
c. at least a portion of said product providers and said patent owners comprising the same entity, and at least one or more of said patents being relevant to one or more of said products in a patent marking sense;
d. correlating patent data and product data from said patent and product databases to create a patent-product map of a selected one or more of said patents which relate to a selected one or more of said products in a patent marking sense; and
c. utilizing said map to provide patent numbers correlated with products.

67. A patent marking method comprising:
in a patent-product marking function or service:
acquiring or developing a patent-product map which correlates product attributes, identifiers or other product data with the numbers of patents which relate to said products in a patent marking sense; and
making said map available on a remotely accessible patent marking link such that upon accessing the link patent marking information can be derived concerning the mapped products; and
in a production or shipping line:
i. automatically accessing a memory containing at least a portion of said map or directly accessing said patent marking function or service;
ii. providing to said memory or said patent marking function or service a product attribute or identifier of a product upon which a patent marking is to be applied;
iii. applying to said product or its package patent data identifying one or more patents downloaded electronically from said memory or said patent marking function or service, which data relates to the marked products in a patent marking sense.

68. The method defined by claim 67 wherein said link is accessed by a production management system.

69. The method defined by claim 67 wherein said link is maintained internally by the provider of said production line.

70. The method defined by claim 67 wherein said link is maintained by an external patent marking service.

71. The method defined by claim 67 wherein said map is a manually developed lookup table.

72. The method defined by claim 67 wherein map is developed by:
accessing one or more local or remote product databases containing product data on a production line provider's products,
accessing one or more local or remote patent databases containing patent data characterizing a plurality of a production line provider's patents, said patent data comprising patent number, and one or more descriptors which characterize the respective patented inventions, at least one or more of said patents being relevant to one or more of said products in a patent marking sense, and
correlating said patent data with said product data.

73. The method defined by claim 67 wherein said patent marking function or service is a for-profit service and said production line is controlled by an entity which contracts with said service to provide the numbers of patents which are relevant to its products in a patent marking sense.

74. The method defined by claim 67 wherein said production line is controlled by a production management system which automatically communicates with said memory or with said function or service in response to a need for the patent data which is relevant in a patent marking sense to products being produced.

75. The method defined by claim 67 wherein said patent data transmitted by said function or service and applied to products in said production line comprises patent numbers in alphanumeric, human readable format.

76. The method defined by claim 67 wherein said patent data transmitted by said function or service and applied to products in said production line comprises patent numbers in coded, machine-readable format.

77. The method defined by claim 67 wherein said patent data is applied to said products in the form of a bar code encoding patent numbers corresponding to said patent data.

78. The method defined by claim 67 wherein said patent data is applied to said products in the form of an RFID transponder having a memory containing patent numbers corresponding to said patent data.

79. The method defined by claim 67 wherein said product identifiers or attributes are selected from the group consisting of product descriptions, brand names, trademarks, model numbers, part numbers, Universal Product Codes, keywords, or technical descriptors and USPTO or WIPO patent classification subclasses relevant to the marked product's various technologies.

80. The method defined by claim 67 wherein the entity marking said products or packages is a package shipper.

81. A patent marking method comprising placing on or in association with products or their packages to be introduced into commerce a patent marking link adapted to be remotely accessed to learn the numbers of patents which relate to the marked products in a patent marking sense.

82. The method defined by claim 81 wherein said link is maintained internally by the owner of the patents.

83. The method defined by claim 81 wherein said link is maintained by a patent marking service.

84. The method defined by claim 83 wherein said patent marking service is a for-profit service and said party placing the link on products contracts with said patent marking service to provide the numbers of patents which are relevant to the marked products in a patent marking sense.

85. The method defined by claim 81 wherein said placing of said patent marking link on products is controlled by a production management system which automatically communicates with said patent marking service in response to a need for the patent data which is relevant in a patent marking sense to products being produced.

86. The method defined by claim 84 wherein said numbers provided by said patent marking service and applied to products comprises patent numbers in alphanumeric, human readable format.

87. The method defined by claim 84 wherein said patent numbers provided by said service and applied to products comprises patent numbers in coded, machine-readable format.

88. The method defined by claim 87 wherein said patent numbers are applied to said products in the form of a bar code.

89. The method defined by claim 87 wherein said patent numbers are applied to said products in the form of an RFID transponder having a memory containing said patent numbers.

90. A method of patent marking comprising distributing with patented products associated storage media containing patent numbers which relate to the products in a patent marking sense.

91. The method defined by claim 90 wherein said media comprises CD ROM or other optical media, magnetic media, or solid state storage media.

92. The method defined by claim 90 wherein said patent numbers are in machine-readable format.

93. The method defined by claim 92 wherein said storage media is a bar code or RFID format.

94. The method defined by claim 90 wherein said storage media includes software to aid in accessing the stored patent numbers.

95. A digital patent marking store adapted to be associated with a product to be patent marked, the store containing coded or uncoded digital data which identifies the number of one or more patents or links to one or more patents which relate to the associated product in a patent marking sense.

96. The digital patent marking store defined in claim 95 wherein the store comprises a CD-ROM, digital video disk or other optically encoded storage medium.

97. The digital patent marking store defined in claim 95 wherein the store comprises a floppy disk or other magnetic storage medium.

98. The digital patent marking store defined in claim 95 wherein the store comprises a semiconductor memory.

99. The digital patent marking store defined in claim 95 wherein the digital data represents digital encoding of data including patent numbers.

100. The digital patent marking store defined in claim 95 wherein the digital data includes a link to a site on the Internet where said patent numbers can be retrieved.

101. The digital patent marking store defined in claim 95 wherein the store comprises a bar code which represents patent marking data, or a link to patent marking data.

102. The digital patent marking store defined in claim 95 wherein the store comprises a radio frequency identification (RFID) memory.

103. The digital patent marking store defined in claim 95 wherein the store comprises a bar code and a radio frequency identification (RFID) memory.

104. The digital patent marking store defined in claim 95 wherein said store includes human readable patent numbers and digital data.

105. The digital patent marking store defined in claim 104 wherein said store comprises a label.

106. The digital patent marking store defined in claim 105 wherein said digital data is stored in a bar code.

107. The digital patent marking store defined in claim 105 wherein said digital data is stored in an RFID memory.

108. A product or product package having thereon, therein, or associated therewith a digital patent marking comprising digital data which identifies the number of one or more patents or links to one or more patents which relate to the product in a patent marking sense.

109. The subject matter of claim 108 wherein the digital data is stored on a CD-ROM, digital video disk or other optically encoded storage medium.

110. The subject matter of claim 108 wherein the digital data is stored on a floppy disk, hard drive, or other magnetic storage medium.

111. The subject matter of claim 108 wherein the digital data is stored on a semiconductor memory.

112. The subject matter of claim 108 wherein the digital data represents digital encoding of data including patent numbers.

113. The subject matter of claim 108 wherein the digital data includes a link to a site on the Internet where said patent numbers can be retrieved.

114. The subject matter of claim 108 wherein the digital data is encoded in the form of a bar code which represents patent marking data, or a link to patent marking data.

115. The subject matter of claim 108 wherein the digital data is stored in a radio frequency identification (RFID) memory.

116. The subject matter of claim 108 wherein the store comprises a bar code and a radio frequency identification (RFID) memory.

117. A method comprising:
a. accessing data on a plurality of patents of at least one predetermined patent owner;
b. acquiring data on at least one selected product of said predetermined patent owner to which said plurality of patents relate;
c. correlating said patents with said selected product of said predetermined patent owner in a patent marking sense, and producing digital data in the form of patent-product correlations; and
d. utilizing the patent-product correlations to patent mark said selected product or its package.

118. The method defined by claim 117 wherein said utilizing comprises downloading certain results of said correlating into a production management system, and applying patent markings to said product or its package through said system.

119. The method defined by claim 118 wherein said production management system is an enterprise resource planning system.

120. The method defined by claim 117 wherein said method includes updating said correlations with digital data updates concerning at least one recent patent grant into said portfolio of said patent owner such that any patent markings made are current.

121. The method defined by claim 120 wherein said updating comprises downloading said digital data updates concerning at least one recent patent grant into a production management system which is employed to apply patent markings to products or product packages.

122. The method defined by claim 120 wherein said updating comprises emailing said digital data updates concerning at least one recent patent grant with instructions to apply the said digital data to the products to which the patent grant applies, or a package therefore.

123. The method defined by claim 117 wherein said utilizing includes applying patent markings including at least patent number information in human readable form.

124. The method defined by claim 117 wherein said utilizing includes applying patent markings including at least bar coded patent number information.

125. The method defined by claim 117 wherein said utilizing includes applying patent markings including at least patent number information stored in a radio frequency identification device.

126. The method defined by claim 117 wherein said utilizing includes applying patent markings including at least patent number information in machine-readable form.

127. The method defined by claim 117 wherein said utilizing includes applying patent markings including at least patent number information in both human readable and machine-readable form.

128. The method defined by claim 117 wherein at the direction of said patent owner, the results of said correlating are supplied to the patent owner's contract manufacturer, VAR, assembler, product packager, component supplier or other outsourced resource for the purpose of applying appropriate patent markings to the product of the patent owner.

129. The method defined by claim 117 wherein at the direction of said patent owner, the results of said correlating are supplied to the patent owner's product shipper, and wherein said method includes the step of the shipper processing said results and applying appropriate patent markings to packages containing said product of the patent owner.

130. The method defined by claim 117 wherein said utilizing includes applying to said selected product or its package a patent marking link to a remote network site where at least patent number information can be obtained.

131. The method defined by claim 117 wherein said site is maintained by a patent marking service provider that provides the patent-product correlation information.

132. The method defined by claim 117 wherein said site is maintained by the patent owner.

133. The method defined by claim 117 wherein said site is a web site which includes a patent-to-product map to aid visitors to the site to identify which patents apply to which features of said product in a patent marking sense.

134. The method defined by claim 133 wherein said site includes a search engine to enable visitors to the site to input product or product feature information and receive from the site at least the numbers of patents which relate to said product or product feature in a patent marking sense.

135. The method defined by claim 134 wherein said data on said selected product or product feature comprises data selected from the group consisting of product number, model number, part number, keyword descriptors, UPC code, brand name, trademark, and perceived patent classifications.

136. The method defined by claim 117 wherein said data on said selected product comprises data selected from the group consisting of product number, model number, part number, keyword descriptors, UPC code, brand name, trademark, and perceived patent classifications.

137. The method defined by claim 117 wherein the product data is acquired at least in part using an Internet browser.

138. The method defined by claim 117 wherein said correlating is performed manually.

139. The method defined by claim 117 wherein is correlating is performed at least in part using computer information processing software.

140. A method comprising:
a. accessing data on the patent portfolios of a plurality of predetermined patent owners;
b. acquiring data on selected products of said predetermined patent owners which relate to said patent portfolios; and
c. respectively correlating said patent portfolios with said selected products of said predetermined patent owners in a patent marking sense.

141. The method defined by claim 140 wherein said accessing comprising accessing said portfolios from patent databases provided by governmental sources.

142. The method defined by claim 140 wherein said accessing comprising accessing said portfolios from said predetermined patent owners.

143. The method defined by claim 140 wherein said data on selected products comprises data selected from the group consisting of product number, model number, part number, keyword descriptors, UPC code, brand name, and trademark.

144. The method defined by claim 140 wherein said method is performed by a patent marking service, and wherein said predetermined patent owners are clients of said service.

145. The method defined by claim 140 wherein the product data is acquired at least in part using an Internet browser.

146. The method defined by claim 140 wherein is correlating is performed at least in part using computer information processing software.

147. A method comprising:
a. distributing a product; and
b. distributing on or in associating with said product or package patent marking information as coded or uncoded digital data.

148. The method defined by claim 147 wherein said patent marking information comprises machine-readable patent markings.

149. The method defined by claim 147 wherein said patent marking information comprises at least bar coded patent number information.

150. The method defined by claim 147 wherein said patent number information is stored in a radio frequency identification device.

151. The method defined by claim 147 wherein said patent marking information comprises a digital patent marking link to a remote network site where at least patent number information can be obtained.

152. The method defined by claim 151 wherein said site is maintained by a patent marking service that provides the patent number information.

153. The method defined by claim 151 including the steps of machine reading said digital patent marking data, accessing said site, and retrieving said patent number information.

154. A method comprising:
a. distributing software, firmware, or other content digital data over a network; and
b. electronically distributing in association with the content digital data patent marking digital data representing at least the numbers of one or more patents which relate to said content digital data in a patent marking sense.

155. The method defined by claim 154 wherein said content digital data is distributed online, and wherein said patent digital data is distributed at the time of distribution of the content digital data.

156. The method defined by claim 155 wherein said patent digital data is embedded in the content digital data.

157. The method defined by claim 156 wherein said patent digital data is presented for sensory retrieval by a user of the content digital data.

158. The method defined by claim 155 wherein said patent digital data is distributed separately from the content digital data.

159. The method defined by claim 154 wherein said content digital data is distributed online, and wherein said patent digital data is distributed after the time of distribution of the content digital data.

160. A method of patent marking a product or its package, comprising acquiring digital data representing patent marking information relevant to said product, and applying or associating said digital data with the product or its package, said digital data being machine readable to obtain at least the numbers of patents related to the product in a patent marking sense, or a link to such numbers.

161. The method defined by claim 160 wherein said associating comprises applying machine-readable patent markings and at least patent number information in human readable form.

162. The method defined by claim 160 wherein said associating comprises applying at least bar coded patent number information.

163. The method defined by claim 160 wherein said associating comprises applying at least patent number information stored in a radio frequency identification device.

164. The method defined by claim 160 wherein said associating comprises applying as a patent marking a link to a remote network site where at least patent number information can be obtained.

165. The method defined by claim 164 wherein said site is maintained by a patent marking service that provides the patent number information.

166. The method defined by claim 164 including the steps of machine reading said digital patent marking data, accessing said site, and retrieving said patent number information.

167. A method comprising:
a. acquiring a product; and
b. thereafter acquiring patent marking information intended for association with the product in a patent marking sense.

168. The method defined by claim 167 including applying or otherwise associating the patent marking information with the product.

169. The method defined by claim 167 wherein the product is acquired in digital form online.

170. The method defined by claim 167 wherein the patent marking information is received as an email.

171. The method defined by claim 167 wherein the patent marking information is received as a download on the Internet.

172. The method defined by claim 167 wherein the patent marking information is received as a label adapted to be applied to the product or its package.

173. A method comprising:
a. distributing a product; and
b. thereafter providing, distributing, or otherwise making available patent marking information for application to or associating with the distributed product.

174. The method defined by claim 173 wherein said patent marking information takes the form of coded or uncoded digital data.

175. The method defined by claim 174 wherein said patent marking information comprises machine-readable patent markings.

176. The method defined by claim 174 wherein said patent marking information is stored in a radio frequency identification device.

177. The method defined by claim 174 wherein the patent marking information is distributed as an email.

178. The method defined by claim 174 wherein the patent marking information is distributed as a download on the Internet.

179. The method defined by claim 174 wherein the patent marking information is distributed as a label adapted to be applied to the product or its package.

180. The method defined by claim 174 wherein said patent marking information includes patent marking information about patents which issued after the product was distributed.

181. A method comprising:
a. distributing digital patent marking information for application to or associating with a product to which the information relates in a patent marking sense; and
b. thereafter updating the patent marking information.

182. The method defined by claim 181 wherein the patent marking information is distributed as an email.

183. The method defined by claim 181 wherein the patent marking information is distributed as a download on the Internet.

184. The method defined by claim 181 wherein said patent marking information includes patent marking information about patents which issued after the initial patent marking information was distributed.

185. The method defined by claim 154 wherein the patent marking digital data is displayed: 1) upon installation or boot-up of the content digital data; 2) in a digital license agreement; 3) as a pop-up during use of the content digital data, or 4) in an electronic user's manual.
